(19) United States
(12) Patent Application Publication
(10) Pub. No.: US 2024/0018027 A1
(43) Pub. Date: Jan. 18, 2024

(54) METHODS FOR ENHANCED BIOLOGICAL PHOSPHORUS REMOVAL

(71) Applicant: HIAS HOW2O AS, Ottestad (NO)

(72) Inventors: Torgeir SALTNES, Eidsvoll (NO); Sondre EIKÅS, Stange (NO); Gjermund SØRENSEN, Stange (NO)

(73) Assignee: HIAS HOW2O AS, Ottestad (NO)

(21) Appl. No.: 18/247,575

(22) PCT Filed: Oct. 7, 2021
(86) PCT No.: PCT/EP2021/077740

§ 371 Date: Mar. 31, 2023

(30) Foreign Application Priority Data
Oct. 7, 2020 (GB) 2015889.5

(51) Int. Cl. C02F 3/30; C02F 3/00; C02F 3/08

(52) U.S. Cl. CPC C02F 3/308; C02F 3/301; C02F 3/006; C02F 3/08; C02F 2209/005; C02F 2209/15; C02F 2209/38; C02F 2209/22

(57) ABSTRACT

The present invention relates to methods for enhanced biological phosphorus removal from water. In particular, the present invention provides methods for enhanced biological phosphorus removal from water by a biofilm in which the amount of oxygen supplied in the aerated step of the method is dependent on the amount of nitrite and/or nitrate detected. The invention also provides water treatment systems for enhanced biological phosphorus removal water.

This invention relates generally to the field of water treatment, in particular to methods for biological phosphorus removal from water by a biofilm.

It is important in the field of water treatment to reduce the amount of phosphorus in the water being treated before the water is discharged back into to the aquatic environment (e.g. into lakes, rivers or seas). If the concentration of phosphorus in water that is introduced back into the environment (e.g. discharged in the effluent from a wastewater treatment plant) is too high, then there can be damaging consequences for the environment. The same can be true when the concentration of nitrogen that is returned back into the aquatic environment is overly high. For example, when the concentration of minerals and nutrients (e.g. phosphorus or nitrogen) returned back into an aquatic environment is too high, eutrophication can occur. Eutrophication can have devastating consequences for life in aquatic systems, sometimes ultimately leaving them devoid of aquatic life (e.g. fish, aquatic insects, etc.). Many countries have strict regulations regarding levels (concentrations) of certain minerals and nutrients (e.g. phosphorus and/or nitrogen) that are acceptable to be returned to aquatic environments (e.g. after treatment of wastewater).

Various methods have been developed that enable the level of phosphorus and/or nitrogen in water being treated to be reduced by the action of microorganisms before the water is discharged back into the environment. Broadly speaking, there are two such types of method, (i) activated sludge methods, and (ii) biofilm methods.

A well-known method of reducing the level of phosphorus in water being treated is so-called Enhanced Biological Phosphorus Removal (EBPR), and this may be performed in the context of an activated sludge method or in the context of a biofilm method. In biofilm methods, microorganisms responsible for the removal of nutrients (e.g. phosphorus and/or nitrogen) are present in (or as part of) a biofilm, the biofilm being in contact with the water being treated. Characteristic features of EBPR methods are that Phosphate Accumulating Organisms (PAOs) are exposed to anaerobic conditions (during which they take up carbon from the water) and then are subsequently exposed to aerobic conditions. During the exposure to aerobic conditions, PAOs use carbon (energy source) that they took up during their exposure to anaerobic conditions, for example they use it in order to take up phosphate from the water being treated. In this way, during exposure to aerobic conditions (after a prior exposure to anaerobic conditions), PAOs take up phosphate from the water, and thus the level of phosphate in the water is reduced before the water is returned to the environment.

Aerobic conditions are typically achieved by supplying air (and thus oxygen) to the microorganisms. This is typically done using an air blower, bubble diffuser, or the like. There is significant energy, and thus cost, associated with supplying the air (e.g. costs of powering air blowers, bubble diffusers, etc.). In many typical EBPR methods, a constant DO-setpoint (dissolved oxygen setpoint) is employed during the aerated step, and air (and thus oxygen) is supplied to meet this DO-setpoint (i.e. to achieve a DO (dissolved oxygen) concentration in the water that is equal to the DO-setpoint concentration).

However, using a constant-DO setpoint does not take into account the actual oxygen requirements of the microorganisms (e.g. PAOs) that are effecting the nutrient removal from the water. With a constant DO-setpoint, it may be the case, for example, that more air (and thus oxygen) is supplied than is actually required for efficient biological phosphorus removal by the PAOs. Thus, there can be unnecessary aeration, and thus there can be unnecessary energy (and thus unnecessary cost) expended in providing aeration that is not actually required by the microorganisms. Also, in the context of biofilm methods for example, simply employing a constant DO-setpoint could result in a biofilm that is not as stable and not operating as effectively (not operating as optimally) as it could if the DO-concentration of the water was dynamically tailored to match the actual oxygen requirements of the microorganisms rather than being essentially constant.

What is needed in the art are new, and preferably improved, methods for biological phosphorus removal from water by a biofilm. Preferably, such methods would enable less oxygen to be supplied during the aerated step whilst maintaining efficient biofilm activity during the aerated step, e.g. maintaining efficient biological phosphorus removal during the aerobic step. The present inventors have recognised this and have addressed this need by developing a biofilm method of EBPR in which the oxygen profile in the biofilm can be dynamically controlled by supplying an amount of air (and thus oxygen) to the system during the aerated step that is based on the actual oxygen requirements of microorganisms (e.g. PAOs) in the biofilm. More specifically, the inventors have found that by adjusting the DO-setpoint (and thus the amount of oxygen supplied) based on the level of nitrite (NO₂) and/or nitrate (NO₃) in the water in the aerated step, EBPR methods achieve excellent removal of phosphorus (phosphate) from water, whilst advantageously providing significant operational energy savings. It is also believed that this method, which matches the air supply (and thus oxygen supply) to the actual oxygen requirements of microorganisms (e.g. PAOs) in the biofilm, leads to the biofilm being more stable and thus more operationally optimal. Also, particularly in the context of methods that effect EBPR and the removal of nitrogen from water being treated (e.g. by simultaneous nitrification-denitrification), controlling the DO-profile in the biofilm is important in order to ensure that anoxic conditions are maintained in deeper layers of the biofilm (as anoxic conditions are important for denitrification by denitrifying bacteria); a high nitrite and/or nitrate level can indicate that oxygen is penetrating too far into the biofilm thus disturbing the anoxic conditions.

Thus, in a first aspect, the present invention provides a method for enhanced biological phosphorus removal from water by a biofilm, said method comprising:
(i) an anaerobic step in which said biofilm is subjected to anaerobic conditions;
(ii) an aerated step in which said biofilm is subjected to aerated conditions by supplying oxygen to the water;
(iii) detecting the level of nitrite and/or nitrate in the water in or after aerated step (ii); wherein the amount of oxygen supplied in aerated step (ii) is dependent on the level of nitrite and/or nitrate detected.

The term “enhanced biological phosphorus removal” (EBPR) is well-known in the art. EBPR methods are characterised by the exposure of microorganisms (including Phosphate Accumulating Organisms (PAOs)) to anaerobic conditions, and then the subsequent exposure of said microorganisms (including Phosphate Accumulating Organisms (PAOs)) to aerated (or aerobic) conditions. During the exposure to anaerobic conditions (i.e. the anaerobic step), PAOs take up organic carbon (an energy source) from the water. During the exposure to aerobic conditions, PAOs are able to use carbon (energy source) that they took up during their exposure to anaerobic conditions in order to take up phosphorus (phosphate) from the water. In this way, during their exposure to aerobic conditions, PAOs take up phosphorus (phosphate) from the water, and thus the level of phosphorus (phosphate) in the water is reduced (i.e. phosphorus (phosphate) is removed from the water).

Typically of course, phosphorus in the water, i.e. the phosphorus to be removed, is in the form of phosphate. “Phosphate” may also be referred to as PO₄ (or PO₄³⁻).

In preferred embodiments, the oxygen supplied in the aerated step is in the form of air. Thus, a preferred type of oxygen supply is air supply.

The level of nitrite and/or nitrate in the water is detected “in or after” aerated step (ii). Preferably, the level of nitrite and/or nitrate in the water is detected “in” aerated step (ii). However, the level of nitrite and/or nitrate in water may alternatively (or additionally) be detected “after” aerated step (ii), for example in treated water that has left a reactor in which the method of the invention may be performed (e.g. in effluent water).

In general terms, a biofilm is a collection, or community, of microorganisms (typically bacteria) surrounded by a matrix of extracellular polymers (e.g. polysaccharides). Biofilms attach to surfaces. Biofilms form readily on surfaces and an established microbial colony on any surface exposed to water (any “wet” surface) could exist as a biofilm structure.

Biofilms in accordance with the present invention comprise Phosphate Accumulating Organisms (PAOs) and nitrifying bacteria (N). Phosphate Accumulating Organisms (PAOs) are sometimes also referred to as Polyphosphate Accumulating Organisms. Nitrifying bacteria may include Ammonia Oxidising Bacteria (AOBs) and/or Nitrite Oxidising Bacteria (NOBs). AOBs can convert ammonium to nitrite. NOBs can convert nitrite into nitrate. Further types of microorganisms that are typically present in biofilms in accordance with the present invention are heterotrophic bacteria (HET) and denitrifying bacteria (DN). Denitrifying bacteria include, for example, denitrifying PAOs (DNPAOs). Thus, denitrifying bacteria in the biofilm may be DNPAOs. DN bacteria (e.g. DNPAOs) can convert nitrite and nitrate generated by the nitrifying (N) bacteria into nitrogen gas or nitrous oxide (N₂O). Glycogen Accumulating Organisms (GAOs) may also be present. GAOs can take up carbon anaerobically and some GAOs may have denitrifying activity (DNGAOs).

Of course, in EBPR biofilm methods, including EBPR methods of the present invention, in the anaerobic step and the aerated step the biofilm is in contact with the water being treated.

“Nitrite” may also be referred to as NO₂ (or NO₂⁻). “Nitrate” may also be referred to as NO₃ (or NO₃⁻). “Ammonium” may also be referred to as NH₄ (or NH₄⁺).

For the avoidance of doubt, in EBPR methods it is not necessary to exogenously introduce (or “seed” or “inoculate”) the biofilms or the microorganisms thereof into the method/system; the microorganisms (bacteria) of the biofilms typically naturally colonize (naturally develop in or are naturally present in) the system/method.

Water to be subjected to (i.e. water to be treated by) an EBPR method in accordance with the invention comprises phosphorus (typically of course in the form of phosphate) and nitrogen (typically in the form of ammonium), as described in more detail elsewhere herein.

During the anaerobic step of the method (anaerobic conditions), PAOs in the biofilm are able to take up (or consume) organic carbon (energy source). Such carbon may, for example, be in the form of short chain/volatile fatty acids (VFA). Without wishing to be bound by theory, PAOs can do this without the presence of an external electron acceptor (such as nitrate or oxygen), e.g. by generating energy from internally stored polyphosphate and glycogen. Many other bacteria in the biofilm do not take up carbon under these conditions and therefore PAOs have a selective advantage in terms of carbon (energy source) uptake as compared to other microorganisms (bacteria) in the biofilm under these conditions. It is for this reason that in EBPR methods there is an anaerobic step (where there is no, or essentially no, nitrate or oxygen present in the water) prior to the aerated step (i.e. to give PAOs preferential access to carbon, for example carbon in influent (untreated) wastewater in the case of wastewater treatment).

After the anaerobic step, the biofilm (and thus the microorganisms in the biofilm) are subjected to an aerated step (exposed to aerated conditions). During the exposure to aerated conditions (aerobic conditions), PAOs can use the carbon (energy source) that was taken up during the anaerobic conditions, for example in order to take up phosphorus (phosphate) from the water. In this way, during exposure to aerobic conditions, PAOs take up phosphate from the water, and thus the level of phosphate in the water is reduced.

Biofilms can comprise bacteria that use oxygen for respiration and bacteria that do not use oxygen for respiration in the same biofilm (e.g. in different layers of the same biofilm). In biofilms, different types of microorganisms (bacteria) can live and grow based on the conditions that they are exposed to (i.e. the conditions that they are subjected to).

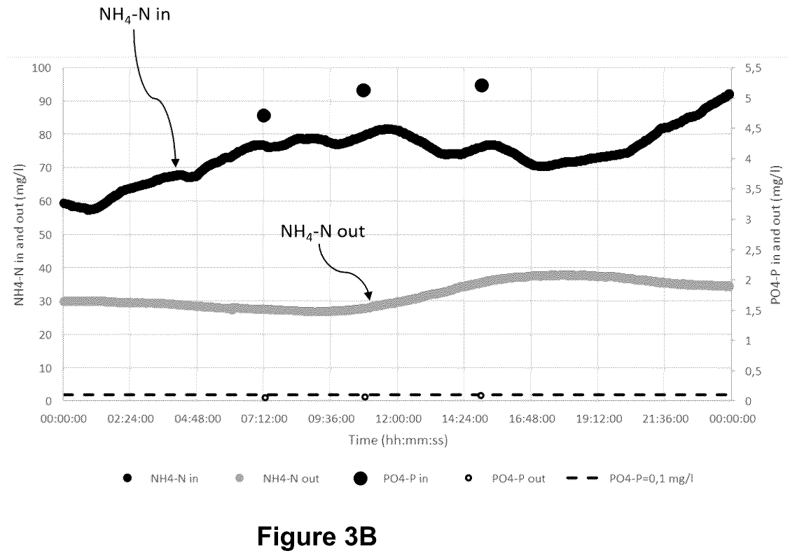

Nitrifying bacteria are slow growing bacteria and compete with PAOs (and HETs) for oxygen in aerated (aerobic) conditions). Unless otherwise clear from the context, references herein to PAOs are references to non-denitrifying PAOs, that are in the aerated (or oxygenated) part of the biofilm when the biofilm is exposed to aerated conditions (i.e. not DNPAOs in the anoxic part of the biofilm). PAOs and HETs are typically faster growing. Nitrifying bacteria (N) typically lose this competition for oxygen, with the faster growing HETs and PAOs having preferential access to the oxygen. Without wishing to be bound by theory, this competition for oxygen is an important parameter in the structuring of the biofilm. In this regard, typically, PAOs are situated (or located) in an outer part (or outer layer) of the biofilm with respect to the part (or layer) of the biofilm in which nitrifying bacteria are situated (or located). Outer part (or layer) is a relative term and means closer to the water (or, alternatively viewed, further from the surface (substrate) on which the biofilm is present). HETs are typically situated (or located) in outer part (or outer layer) with respect to the PAOs. Further into the biofilm (i.e. in a deeper part/layer that is deeper than the part/layer in which the nitrifying bacteria reside), there may be no oxygen; the conditions may be anoxic (no (or essentially no) oxygen but with NO₂ or NO₃) or anaerobic (no oxygen and no NO₂ or NO₃). The anoxic part/layer of the biofilm may contain denitrifying bacteria (DN), e.g. DNPAOs. DN bacteria (e.g. DNPAOs) are able to use nitrate/nitrite instead of oxygen. DN bacteria (e.g. DNPAOs) are thus able to live in the anoxic part of the biofilm. DNPAOs are typical DN bacteria that are present in EBPR methods. Thus, the biofilm may be structured such that the types of organism therein are located (or layered or positioned) within the biofilm based on the oxygen profile (or oxygen gradient) within the biofilm and how the various microorganisms compete for (or require) oxygen. This is, for example, shown schematically in FIG. 4 herein. PAOs outcompete nitrifying bacteria (N) for oxygen. HETs typically outcompete PAOs for oxygen. Denitrifying bacteria (DN), e.g. DNPAOs, typically live and grow in anoxic conditions (and thus in an anoxic part/layer of the biofilm).

In terms of phosphorus removal from water, it is important that PAOs receive (i.e. are exposed to) sufficient oxygen during the aerated step. If nitrite (NO₂) and/or nitrate (NO₃), which are produced by the nitrifying bacteria (N) (nitrifying bacteria convert ammonium into nitrite and nitrate), is detected in the water during the aerated step, this is indicative that both the HETs and the PAOs have received enough oxygen, as oxygen has now reached even the slower growing nitrifying bacteria (N) in the biofilm (which are typically located deeper in the biofilm). Thus, the detection of nitrite and/or nitrate (e.g. at a concentration above a given nitrite and/or nitrate setpoint) is indicative that PAOs in the biofilm have received enough oxygen to carry out the process of biological phosphorus removal from the water (i.e. to effect uptake of phosphorus from the water) and, as described elsewhere herein, this is indicative that the air supply (and thus the oxygen supply) can be decreased (which is typically done by decreasing the DO-setpoint of the aerated step). Conversely, if no significant nitrite (NO₂) and/or nitrate (NO₃) is detected in the water (e.g. nitrite and/or nitrate is detected at a concentration that is below a given nitrite and/or nitrate setpoint), this is indicative that both the HETs and the PAOs may not have yet received enough oxygen, as oxygen has not reached the slower growing nitrifying bacteria (N) in the biofilm, and thus is indicative that the air supply (and thus the oxygen supply) should be increased. By detecting (e.g. constantly detecting) the concentration of nitrite and/or nitrate in the water during an aerated step, and adjusting the DO-setpoint (if necessary) on the basis of the nitrite and/or nitrate concentration detected, the present method ensures that the oxygen requirements of the relevant bacteria (e.g. PAOs) are being met, whilst at the same time not supplying more oxygen than is actually needed. This is advantageous (e.g. in terms of operational energy savings), as discussed elsewhere herein.

Thus, in some embodiments of methods of the present invention, the amount of oxygen supplied in aerated step (ii) is increased when the level of nitrite and/or nitrate detected (or determined or measured or quantified) in or after aerated step (ii) is decreased or is decreasing. The result of such an increase in oxygen supply is of course that the DO concentration of the water is increased (or elevated). The decreased (or decreasing) level of nitrite and/or nitrate is typically relative to (i.e. with respect to or in comparison to) a nitrite and/or nitrate setpoint. This setpoint may be a nitrite concentration setpoint. This setpoint may be a nitrate concentration setpoint. This setpoint may be a setpoint for the combined concentration of nitrite and nitrate (i.e. a sum of the nitrite and nitrate concentrations).

Thus, in some embodiments of methods of the present invention, the amount of oxygen supplied in aerated step (ii) is increased (or elevated) when the level of nitrite and/or nitrate detected (or determined or measured or quantified) in or after aerated step (ii) is lower than (e.g. significantly lower than), or below (e.g. significantly below), a nitrite and/or nitrate setpoint. In some embodiments of methods of the invention, the amount of oxygen supplied in aerated step (ii) is increased when the level of nitrite and/or nitrate detected (or determined or measured or quantified) in or after aerated step (ii) drops below (e.g. significantly below) a nitrite and/or nitrate setpoint. The result of such an increase in oxygen supply is of course that the DO concentration of the water is increased (or elevated).

In some embodiments of methods of the present invention, the amount of oxygen supplied in aerated step (ii) is decreased when the level of nitrite and/or nitrate detected (or determined or measured or quantified) in or after aerated step (ii) is increased or is increasing. The result of such a decrease in oxygen supply is of course that the DO concentration of the water is decreased (or reduced). The increased (or increasing) level of nitrite and/or nitrate is typically relative to (i.e. with respect to or in comparison to) a nitrite and/or nitrate setpoint. This setpoint may be a nitrite concentration setpoint. This setpoint may be a nitrate concentration setpoint. This setpoint may be a setpoint for the combined concentration of nitrite and nitrate (i.e. a sum of the nitrite and nitrate concentrations).

Thus, in some embodiments of methods of the present invention, the amount of oxygen supplied in aerated step (ii) is decreased (or lowered) when the level of nitrite and/or nitrate detected (or determined or measured or quantified) in or after aerated step (ii) is higher than (e.g. significantly higher than), or above (e.g. significantly above), a nitrite and/or nitrate setpoint. In some embodiments of methods of the present invention, the amount of oxygen supplied in aerated step (ii) is decreased when the level of nitrite and/or nitrate detected (or determined or measured or quantified) in or after aerated step (ii) rises above (e.g. significantly above) a nitrite and/or nitrate setpoint. The result of such a decrease in oxygen supply is of course that the DO concentration of the water is decreased (or lowered).

In preferred embodiments, the amount of oxygen supplied in aerated step (ii) is increased (or elevated) when the level of nitrite and/or nitrate detected (or determined or measured or quantified) in or after aerated step (ii) is lower than (e.g. significantly lower than), or below (e.g. significantly below), a nitrite and/or nitrate setpoint, and the amount of oxygen supplied in aerated step (ii) is decreased (or lowered) when the level of nitrite and/or nitrate detected (or determined or measured or quantified) in or after aerated step (ii) is higher than (e.g. significantly higher than), or above (e.g. significantly above), a nitrite and/or nitrate setpoint.

In some preferred embodiments, the amount of oxygen supplied in aerated step (ii) is increased when the level of nitrite and/or nitrate detected (or determined or measured or quantified) in or after aerated step (ii) drops below (e.g. significantly below) a nitrite and/or nitrate setpoint and the amount of oxygen supplied in aerated step (ii) is decreased when the level of nitrite and/or nitrate detected (or determined or measured or quantified) in or after aerated step (ii) rises above (e.g. significantly above) a nitrite and/or nitrate setpoint.

In preferred embodiments, the amount of oxygen supplied in aerated step (ii) is increased when the level of nitrite and/or nitrate detected (or determined or measured or quantified) in or after aerated step (ii) is decreased or is decreasing, and the amount of oxygen supplied in aerated step (ii) is decreased when the level of nitrite and/or nitrate detected (or determined or measured or quantified) in or after aerated step (ii) is increased or is increasing.

The nitrite and/or nitrate levels (or concentrations) may be determined by any suitable means (e.g. using nitrite and/or nitrate sensors, e.g. in-line nitrite and/or nitrate sensors). The skilled person in the field of water treatment is familiar with suitable means for determining nitrite and/or nitrate levels (or concentrations). In some embodiments, in-line nitrite and/or nitrate concentrations are measured. “In-line” sensors or “in-line” concentrations may also be referred to as “on-line” sensors or “on-line” concentrations, respectively. Examples of suitable sensors for determining nitrite and/or nitrate levels include sensors of the Spectro::lyser range (e.g. Spectro::lyser V3) of S::can Messtechnik GmbH (Austria).

The nitrite and/or nitrate levels (e.g. as compared to a setpoint) may be determined qualitatively or quantitatively, but quantitative measurements are preferred. Nitrite and/or nitrate levels (or concentrations) may, in some embodiments, be conveniently measured in mg/l (or any other convenient units).

An “increase” in the level or “increased” level or “increasing” level of nitrite and/or nitrate includes any measurable increase or elevation, e.g. relative to (i.e. with respect to or in comparison to) a nitrite and/or nitrate setpoint. In some cases, the level may be significantly increased, e.g. relative to (i.e. with respect to or in comparison to) a nitrite and/or nitrate setpoint.

A level of nitrite and/or nitrate that is “higher than” or “above” a nitrite and/or nitrate setpoint includes any measurable level higher than, or above, a nitrite and/or nitrate setpoint. In some cases, the level may be significantly higher than, or significantly above, a nitrite and/or nitrate setpoint.

A “decrease” in the level or “decreased” level or “decreasing” level of nitrite and/or nitrate includes any measurable decrease or reduction, e.g. relative to (i.e. with respect to or in comparison to) a nitrite and/or nitrate setpoint. In some cases, the level may be significantly decreased, e.g. relative to (i.e. with respect to or in comparison to) a nitrite and/or nitrate setpoint.

A level of nitrite and/or nitrate that is “lower than” or “below” a nitrite and/or nitrate setpoint includes any measurable level lower than, or below, a nitrite and/or nitrate setpoint. In some cases, the level may be significantly lower than, or significantly below, a nitrite and/or nitrate setpoint.

In some preferred embodiments, the amount of oxygen supplied to the water (and thus the DO concentration of the water in the aerated step) is adjusted (when necessary) to maintain a level of nitrite and/or nitrate in the water in the aerated step that is at, or close to (e.g. preferably no more than 250% of, or no more than 200% of, or no more than 150% of, or no less than 70% of, or no less than 50% of), the nitrite and/or nitrate setpoint (setpoint concentration). The aim is typically to achieve a nitrite and/or nitrate concentration in the aerated water that is equal to (or essentially equal to) to the setpoint.

Thus, in some embodiments, the level (or concentration) of nitrite and/or nitrate in the water in the aerated step is maintained (e.g. is always is maintained) at, or close to (e.g. preferably no more than 250% of, or no more than 200% of, or no more than 150% of, or no less than 70% of, or no less than 50% of), the nitrite and/or nitrate setpoint (setpoint concentration).

In some embodiments, the level (or concentration) of nitrite and/or nitrate in the water in the aerated step may be constantly detected (constantly measured or constantly monitored or constantly determined).

In some preferred embodiments, there is a constant feedback loop in operation, wherein the amount (or flow or rate) of oxygen supplied to the water (and thus the DO concentration of the water in the aerated step) is constantly adjusted (when necessary) to maintain a level of nitrite and/or nitrate in the water in the aerated step that is at, or close to (e.g. preferably no more than 250% of, or no more than 200% of, or no more than 150% of, or no less than 70% of, or no less than 50% of) the nitrite and/or nitrate setpoint (setpoint concentration).

A “setpoint” as used herein is a desired or target value (e.g. desired or target level or concentration) for a variable in a system or method (e.g. an essential variable in a system or method). Alternatively viewed, a setpoint may be considered a predetermined value (e.g. concentration or level), or a predetermined target value (or a predetermined target concentration or level). A departure (or variation) from a setpoint in a method or system can thus be used as a basis for a feedback system (or feedback loop) for controlling a method or system.

A nitrite and/or nitrate setpoint in accordance with the present invention is thus the desired or target level (i.e. desired or target level or value) of nitrite and/or nitrate in the water in the aerated step.

In some embodiments, a nitrite (NO₂, typically NO₂—N) concentration (or level) setpoint is used.

In some embodiments, a nitrate (NO₃, typically NO₃—N) concentration (or level) setpoint is used.

In some embodiments, a combination of nitrite (NO₂) and nitrate (NO₃) concentrations (or levels) may be used as the setpoint. The combination of nitrite (NO₂) and nitrate (NO₃) may be referred to as NOx. Thus, a NOx setpoint (e.g. NOx-N setpoint) may be used. NOx concentration (or level) is a sum of nitrite (NO₂) and nitrate (NO₃) concentration. In some cases, when using a NOx setpoint, a different weighting may be given to each of the nitrite (NO₂) and nitrate (NO₃) concentrations when summing the two concentrations to generate a NOx concentration value. For example, in some cases when using a NOx setpoint, the NOx concentration value (to be compared to the NOx setpoint) may be the sum of the NO₂—N concentration and “X” times the NO₃—N concentration (for example “X” may be in the range 0-3, e.g. 1.5). Put another way, in some cases NOx-N may equal NO₂—N+“X”×NO₃—N).

Any suitable nitrite (e.g. NO₂—N) and/or nitrate (e.g. NO₃—N) level (or concentration) may be used as the setpoint and the skilled person would be able to select a suitable setpoint. Generally speaking, a nitrite and/or nitrate setpoint concentration is a concentration that shows that at least some, but preferably just a little, nitrite and/or nitrate is present in the water. This indicates that oxygen has reached (i.e. has been accessed by) nitrifying bacteria in the biofilm and that some ammonium has been converted to nitrite and/or nitrate.

The nitrite and/or nitrate setpoint concentration (or level) may be any measurable concentration (or level). In some embodiments, the nitrite and/or nitrate setpoint is in the range of 0.5-5 mg/l, 0.5-2.5 mg/l, 0.5-2 mg/l, 0.5-1.5 mg/l, 0.5-mg/l, 1-5 mg/l, 1-2.5 mg/l, 1-2 mg/l, 1-1.5 mg/l, or 1.5-5 mg/l, 1.5-2.5 mg/l, 1.5-2 mg/l. In preferred embodiments, the nitrite and/or nitrate setpoint may be in the range of 1-2 mg/l. In one preferred embodiment, the nitrite and/or nitrate setpoint is 1.5 mg/l. The nitrite and/or nitrate setpoint may in some embodiments be up to 5 mg/l, up to 2.5 mg/l, up to 2 mg/l or up to 1.5 mg/l. The nitrite and/or nitrate setpoint may in some embodiments be at least 0.5 mg/l, at least 1 mg/l, at least 1.5 mg/l, at least 2 mg/l, at least 2.5 mg/l or at least 5 mg/ml.

Typically and preferably, the amount (or rate or flow) of oxygen supplied in the aerated step of methods of the present invention is adjusted (if necessary) by adjusting a DO-setpoint (dissolved oxygen setpoint). Thus, the DO-setpoint may be considered a “floating” or “adjustable” setpoint. The DO-concentration of (or level in) the water may be determined by (and thus may be monitored by) one or more DO-sensors. Accordingly, the concentration of DO in the water relative to a DO-setpoint) may thus be monitored.

In methods of the present invention, the DO-setpoint may be adjusted (i.e. increased or decreased as the case may be) depending on the level (or concentration) of the nitrite and/or nitrate concentration detected in the water in the aerated step (e.g. in the water in the aerated chamber/zone of a reactor), and adjustment of the DO-setpoint results in an adjustment (i.e. increase or decrease as the case may be) in the amount (or rate or flow) of oxygen (typically air) supplied. Typically, there is at least one controller (or set of controllers) that controls (and adjusts) the DO-setpoint in response to the nitrite and/or nitrate concentration detected in the water in the aerated step.

Thus, the DO-setpoint, and accordingly the oxygen supply, in the aerated step (e.g. in the water in the aerated chamber/zone of a reactor), may be adjusted (or varied or altered or modulated) during the performance of the method, with the adjustment (or variation or alteration or modulation) being a function of (i.e. dependent on) the nitrite and/or nitrate concentration (or level) determined. Thus, in some embodiments, the DO-setpoint, and accordingly the oxygen supply, in the aerated step (e.g. in the water in the aerated chamber/zone of a reactor), are adjusted (or varied) during the performance of the method, with the adjustment (or variation) being a function of (i.e. dependent on) the measured (or determined or detected) nitrite and/or nitrate concentration relative to the nitrite and/or nitrate setpoint. Speaking in very general terms, the DO-setpoint can be considered as providing a “target” level (or concentration) of DO to be hit (or achieved or met), with the “target” level (or concentration) being adjusted (if necessary) based on the measured nitrite and/or nitrate concentration in the water in the aerated step.

In some embodiments, there may be a single individual DO-setpoint (which is of course adjustable in accordance with the invention) in aerated step (ii). Thus, in some cases, there may be a single individual DO-setpoint concentration in operation for the entire aerated chamber of a reactor. However, in other embodiments there can be multiple different DO-setpoints in operation in aerated step (ii). Thus, in some embodiments, there may be two or more different DO-setpoints in operation in aerated step (ii). Such different DO-setpoints together may form a DO-setpoint profile, and the DO-setpoint profile (e.g. the whole profile) may be adjusted (increased or decreased) based on the level of nitrite and/or nitrate detected in accordance with the invention. As used herein, the term “DO-setpoint” includes also DO-setpoint profiles, in addition of course to individual DO-setpoints.

Typically, in embodiments in which there are multiple different DO-setpoints operating as a DO-setpoint profile, each different DO-setpoint operates in a different location within an aerated chamber of a reactor in which the method is being performed. As discussed elsewhere herein, the aerated chamber of a reactor may be separated into multiple sub-chambers. Different sub-chambers are an example of different locations within an aerated chamber.

In embodiments in which there is a DO-setpoint profile in operation (a profile formed from multiple different DO-setpoints), DO-setpoint(s) within the profile that are at (or close to) the beginning of the aerated chamber of a reactor (e.g. in the first or in early aerated sub-chambers thereof) may be higher than DO-setpoint(s) within the profile that are at (or close to) the end of the aerated chamber (e.g. in the last or in later aerated sub-chambers thereof). Alternatively viewed, in embodiments in which there is a DO-setpoint profile in operation, there may be a gradient of different DO-setpoints within the profile, said gradient being characterised by comprising DO-setpoint(s) in the first (or early or beginning) part of the aerated chamber (e.g. in the first or in early aerated sub-chambers thereof) that are higher than DO-setpoint(s) in the last (or late(r) or end) part of the aerated chamber (e.g. in the last or in later aerated sub-chambers thereof). For the avoidance of doubt, the beginning (or first or early) part of the aerated chamber is the part closest to the anaerobic chamber and the last (or late(r) or end) part of the aerated chamber is the part closest to the water outlet/effluent. Without wishing to be bound by theory, in cases where there are multiple different DO-setpoints forming a DO-setpoint profile, using DO setpoints that are higher in the first part of the aerated chamber as compared to in the later part of the aerated chamber is typically beneficial as there is a higher carbon load in the water in the first part of the aerated chamber (it is closer to the influent water), therefore there is typically a higher oxygen demand.

As discussed above, when a DO-setpoint profile is used, the DO-setpoint profile (e.g. the whole profile) may be adjusted (increased or decreased as the case may be) based on the level of nitrite and/or nitrate detected in accordance with the invention. The whole profile may be increased (or elevated), or the whole profile may be decreased (or lowered). Of course, low nitrite and/or nitrate levels (typically relative to a nitrite and/or nitrate setpoint) would lead to an increase in the profile, and high nitrite and/or nitrate levels (typically relative to a nitrite and/or nitrate setpoint) would lead to a decrease in the profile. In some embodiments, the same increase or decrease (same degree or same extent of increase or decrease) is not made to all of the different DO-setpoints in the profile. In this regard, in some embodiments, in response to a detection of an increase in the level of nitrite and/or nitrate, the DO-setpoint profile is decreased (entire profile is decreased), with the higher DO-setpoints within the profile being decreased to a greater extent than the decrease(s) made to the lower DO-setpoints within the profile. Conversely, in some embodiments, in response to a detection of a decrease in the level of nitrite and/or nitrate, the DO-setpoint profile is increased (entire profile is increased), with the higher DO-setpoints within the profile being increased to a greater extent than the increase(s) made to the lower DO-setpoints within the profile.

Typically, the level (or concentration) of DO is detected (or determined or measured or quantified) in aerated step (ii), typically by at least one DO-sensor, and said detected level is compared to a DO-setpoint by at least one first controller (the DO level detected is communicated to, and received by, said controller), and the oxygen (e.g. air) supply in the aerated step is adjusted if necessary (e.g. increased or decreased as the case may be) by said at least one first controller such that the DO level (or concentration) in the water in aerated step (ii) is adjusted to the DO-setpoint concentration (e.g. oxygen supply is increased or decreased as the case may be in order that the DO level in the water in aerated step (ii) is increased or decreased to meet the DO-setpoint concentration).

In preferred such embodiments, the level (or concentration) of nitrite and/or nitrate is detected (or determined or measured or quantified) in or after aerated step (ii), typically by at least one nitrite and/or nitrate-sensor, and said level of nitrite and/or nitrate detected is compared to a nitrite and/or nitrate-setpoint by at least one second controller (the nitrite and/or nitrate level detected is communicated to, and received by, said controller), and if the level of nitrite and/or nitrate is different from (i.e. deviates from, or is not in accordance with, or does not match) the nitrite and/or nitrate setpoint, said at least one second controller communicates with (or signals to) said at least one first controller, instructing (or causing) said at least one first controller to adjust the DO-setpoint. The DO-setpoint is adjusted (increased or decreased as the case may be) such that the DO-concentration in the water in step aerated (ii) is adjusted accordingly (increased or decreased as the case may be), thereby adjusting (increasing or decreasing) the concentration of nitrite and/or nitrate in the water in the aerated step (ii) to (or in the direction of, or to meet) the nitrate and/or nitrite setpoint concentration.

In some such embodiments, when an increase in the nitrite and/or nitrate concentration in the water in or after aerated step (ii) relative to the nitrite and/or nitrate setpoint is determined by said at least one second controller, said at least one second controller communicates with (i.e. sends a signal to) said at least one first controller instructing (or causing) said at least one first controller to decrease the DO-setpoint (thereby the oxygen supply to the water is decreased). This would lead to the decrease in nitrite and/or nitrate concentration in the water.

In some other such embodiments, when a decrease in the nitrite and/or nitrate concentration in the water in or after aerated step (ii) relative to the nitrite and/or nitrate setpoint is determined by said at least one second controller, said at least one second controller communicates with (i.e. sends a signal to) said at least one first controller instructing (or causing) said at least one first controller to increase the DO-setpoint (thereby the oxygen supply to the water is increased). This would lead to the increase in nitrite and/or nitrate concentration in the water.

Thus, methods of the present invention may be controlled by (i) a controller that compares a detected DO-level to a DO-setpoint and if necessary adjusts the oxygen (e.g. air) supply to the water, and (ii) a controller that compares a detected nitrite and/or nitrate level to a nitrite and/or nitrate-setpoint and, if necessary, instructs (or causes) controller (i) to adjust the DO-setpoint. Together, these two types of controller can be used to control methods in accordance with the invention.

As discussed elsewhere herein, there may be a single individual DO-setpoint in operation for the aerated step (ii) (e.g. for the entire aerated chamber of a reactor) or there may be multiple different DO-setpoints in operation in aerated step (ii).

Thus, there may be a single individual DO-sensor in operation in aerated step (ii), or there may be more than one DO-sensor (e.g. 2, 3, 4, 5, 6, 7, 8, etc.) in operation. Typically, when there are more than one DO-sensors they are each at a different location (or position) within the aerated chamber of a reactor in which a method of the present of the present invention is being carried out. Said different locations may be different sub-chambers of a reactor, as described elsewhere herein. The level (or concentration) of DO detected by each of the DO-sensors is typically communicated to its respective controller that compares the detected DO-level to a DO-setpoint. Each of the locations (e.g. sub-chambers) in the aerated chamber of a reactor may have the same DO-setpoint, but typically there would be different DO-setpoints at different locations (as described elsewhere herein). Thus, a given controller that receives a signal of the DO level from its respective DO sensor may compare said DO-level to the DO-setpoint for that respective location (e.g. compare it to the DO-setpoint for the same sub-chamber in which the DO sensor was located), and supply air to that location such that the DO level (or concentration) in the water is adjusted to (i.e. or becomes adjusted to, or meets) the DO-setpoint.

Thus, a different amount (or rate or flow) of air may be supplied to different locations in the aerated chamber of a reactor (e.g. to different aerated sub-chambers) depending on the measured DO levels and the DO-setpoints at different locations. Of course, in some cases, not all of the locations (e.g. not all of the aerated sub-chambers) in the reactor have DO sensors (and corresponding controllers). In some embodiments, locations (e.g. aerated sub-chambers) that do not have a DO sensor (i.e. do not have their own DO sensor) may be supplied with an amount of air based on the measured DO levels and DO-setpoint of an adjacent aerated sub-chamber that does have a DO sensor (i.e. that does have its own DO sensor (and corresponding controller)).

Typically there is at least one means provided for determining the concentration (or level) of nitrite and/or nitrate in the water in or after aerated step (ii) (e.g. at least one nitrite and/or nitrate sensor). In some embodiments, there may be only one (i.e. a single) means provided for determining the concentration (or level) of nitrite and/or nitrate in the water in or after aerated step (ii) (e.g. only one nitrite and/or nitrate sensor). In other embodiments, there may be more than one (i.e. multiple or a plurality) of means for determining the concentration (or level) of nitrite and/or nitrate in the water in or after aerated step (ii) (e.g. more than one nitrite and/or nitrate sensor).

In embodiments in which there is only one means provided for determining the concentration (or level) of nitrite and/or nitrate in the water in or after aerated step (ii) (e.g. only one nitrite and/or nitrate sensor), and there are different locations in the aerated chamber having different DO-setpoints, it may be particularly useful to employ a DO-setpoint profile and adjust said profile based on the nitrite and/or nitrate level detected (as discussed elsewhere herein).

In embodiments in which there is only one means (e.g. sensor) provided for determining the concentration (or level) of nitrite and/or nitrate in the water, it may preferably be positioned at a location in the aerated chamber in which the water at that location is at between about 25% and about 75% (for example between about 35% to about 65% or between about 40% to about 60%) of the total retention time for water in the aerated chamber. In embodiments in which there are two means provided for determining the concentration (or level) of nitrite and/or nitrate in the water (each operating with its own respective controller), it may be useful to have the second means (e.g. second sensor) positioned at, or close to (or in the vicinity of), the end of the aerated chamber (e.g. close to the outlet).

In some embodiments in which there are more than one means (e.g. more than one sensor) in the aerated chamber for determining the concentration (or level) of nitrite and/or nitrate in the water these would typically be positioned at different locations in the aerated chamber.

In some embodiments in which there are more than one means (e.g. more than one sensor) in the aerated chamber for determining the concentration (or level) of nitrite and/or nitrate in the water, the concentration of nitrite and/or nitrate determined by a given means/sensor (a given individual means/sensor) relative to the nitrate and/or nitrite setpoint may be used to control (or adjust) a DO setpoint for the water in a given location in the aerated chamber (e.g. a given sub-chamber(s) or a part or a region of the aerated chamber). Typically, said given location may be the same as the location in which the (respective) means/sensor for determining nitrate and/or nitrite concentration is located, or said given location may substantially correspond to (or be close to or be in the vicinity of the location in which the given means/sensor for determining nitrate and/or nitrite concentration is located (e.g. adjacent sub-chamber(s)). In some embodiments there may thus be more than one second controller (as described elsewhere herein), each of said second controllers signalling to a different first controller or signalling to a different group of first controllers to control the DO-setpoint in given location in the aerated chamber.

In some embodiments in which the method is operated in a reactor comprising an aerated chamber separated into multiple sub-chambers, each sub-chamber may be provided with a means for determining the concentration (or level) of nitrite and/or nitrate in the water and a means for a means for determining the concentration of dissolved oxygen (DO) in water, each of said means operating with its own respective controller.

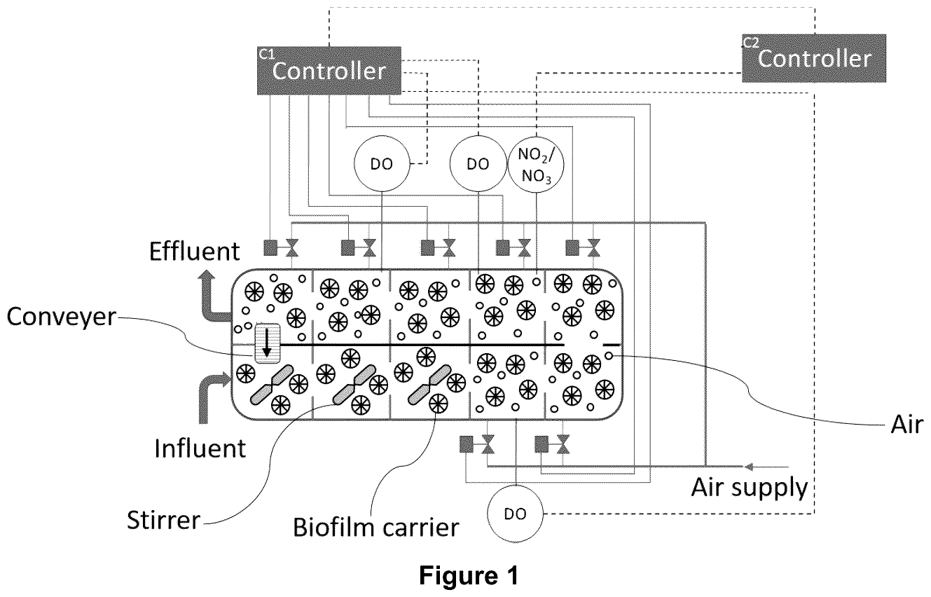

One exemplary and preferred setup for controlling methods of the present invention is depicted schematically in FIG. 1 herein (see also the legend to FIG. 1 and the discussion in Example 1).

A preferred type of controller in accordance with the present invention is a PID controller (proportional-integral-derivative controller). PID controllers are well-known in the art.

In some embodiments of methods of the present invention, the DO-setpoint (and consequentially the amount or rate or flow of oxygen supplied) in aerated step (ii) is increased when the level of nitrite and/or nitrate detected (or determined or measured or quantified) in or after aerated step (ii) is decreased or is decreasing. The result of such an increase of the DO-setpoint is typically of course that the DO concentration of the water is increased (or elevated). The decreased (or decreasing) level of nitrite and/or nitrate is typically relative to (i.e. with respect to or in comparison to) a nitrite and/or nitrate setpoint.

Thus, in some embodiments of methods of the invention, the DO-setpoint (and consequentially the amount or rate or flow of oxygen supplied) in aerated step (ii) is increased when the level of nitrite and/or nitrate detected (or determined or measured or quantified) in or after aerated step (ii) is lower than (e.g. significantly lower than), or below (e.g. significantly or substantially below), a nitrite and/or nitrate setpoint. In some embodiments of methods of the invention, the DO-setpoint in aerated step (ii) is increased when the level of nitrite and/or nitrate detected (or determined or measured or quantified) in or after aerated step (ii) drops below (e.g. significantly below) a nitrite and/or nitrate setpoint.

In some embodiments of methods of the present invention, the DO-setpoint (and consequentially the amount or rate or flow of oxygen supplied) in aerated step (ii) is decreased when the level of nitrite and/or nitrate detected (or determined or measured or quantified) in or after aerated step (ii) is increased or is increasing. The result of such a decrease of the DO-setpoint is typically of course that the DO concentration of the water is decreased (or reduced). The increased (or increasing) level of nitrite and/or nitrate is typically relative to (i.e. with respect to or in comparison to) a nitrite and/or nitrate setpoint.

Thus, in some embodiments of methods of the invention, the DO-setpoint (and consequentially the amount or rate or flow of oxygen supplied) in aerated step (ii) is decreased when the level of nitrite and/or nitrate detected (or determined or measured or quantified) in or after aerated step (ii) is higher than (e.g. significantly higher than), or above (e.g. significantly above), a nitrite and/or nitrate setpoint. In some embodiments of methods of the invention, the DO-setpoint in aerated step (ii) is decreased when the level of nitrite and/or nitrate detected (or determined or measured or quantified) in or after aerated step (ii) rises above (e.g. significantly above) a nitrite and/or nitrate setpoint.

In preferred embodiments, the DO-setpoint (and consequentially the amount or rate or flow of oxygen supplied) in aerated step (ii) is increased when the level of nitrite and/or nitrate detected (or determined or measured or quantified) in or after aerated step (ii) is lower than (e.g. significantly lower than), or below (e.g. significantly or substantially below), a nitrite and/or nitrate setpoint, and the DO-setpoint (and consequentially the amount or rate or flow of oxygen supplied) in aerated step (ii) is decreased when the level of nitrite and/or nitrate detected (or determined or measured or quantified) in or after aerated step (ii) is higher than (e.g. significantly higher than), or above (e.g. significantly above), a nitrite and/or nitrate setpoint.

In some preferred embodiments, the DO-setpoint in aerated step (ii) is increased when the level of nitrite and/or nitrate detected (or determined or measured or quantified) in or after aerated step (ii) drops below (e.g. significantly below) a nitrite and/or nitrate setpoint, and the DO-setpoint in aerated step (ii) is decreased when the level of nitrite and/or nitrate detected (or determined or measured or quantified) in or after aerated step (ii) rises above (e.g. significantly above) a nitrite and/or nitrate setpoint.

In preferred embodiments, the DO-setpoint in aerated step (ii) is increased when the level of nitrite and/or nitrate detected (or determined or measured or quantified) in or after aerated step (ii) is decreased or is decreasing, and the DO-setpoint in aerated step (ii) is decreased when the level of nitrite and/or nitrate detected (or determined or measured or quantified) in or after aerated step (ii) is increased or is increasing.

A DO-setpoint in accordance with the present invention is the desired or target level (i.e. desired or target level or value) of DO in the water in the aerated step.

The amount (or rate or flow) of air (and thus oxygen) supplied in the aerated step may, in some embodiments, be conveniently measured in m³/h (or any other convenient units). Purely by way of example, in some embodiments, the amount (or rate or flow) of air (and thus oxygen) supplied in the aerated step is in the region of 500-2000 m³/h, but of course the amount will depend on multiple factors e.g. the size of reactor and, importantly in the context of the present invention, the level (or concentration) of nitrite and/or nitrate detected.

The DO-setpoint (which is typically adjusted during the aerated step) may in some embodiments be in the range of (and may remain in the range of throughout the aerated step) 1-10 mg/l, 1-9 mg/l, 1-8 mg/l, 1-7 mg/l, 1-6 mg/l, 1-5 mg/l, 1-4 mg/l, 1-3 mg/l, 1-2 mg/l, 2-10 mg/l, 2-9 mg/l, 2-8 mg/l, 2-7 mg/l, 2-6 mg/l, 2-5 mg/l, 2-4 mg/l, 2-3 mg/l, 5-10 mg/l, 5-9 mg/l, 5-8 mg/l, 5-7 mg/l, or 5-6 mg/l. The DO-setpoint (which is typically adjusted during the aerated step) may be up to 2 mg/l, up to 3 mg/l, up to 4 mg/l, up to 5 mg/l, up to 6 mg/l, up to 7 mg/l, up to 8 mg/l, up to 9 mg/l, or up to 10 mg/l. The DO-setpoint (which is typically adjusted during the aerated step) may be at least 1 mg/l, at least 2 mg/l, at least 3 mg/l, at least 4 mg/l, or at least 5 mg/l. Of course, the DO-setpoint is adjustable and, importantly in the context of the present invention, would vary dependent on the level (or concentration) of nitrite and/or nitrate detected in the water in the aerated step. Put another way, the DO-setpoint at a given time is dependent on the level (or concentration) of nitrite and/or nitrate detected in the water in the aerated step.

Typically, it is not desirable for the level of nitrite and/or nitrate concentration to rise (or to be) too high during the aerated step, as high nitrite concentrations can be associated with the inhibition of phosphorus removal by PAOs. Controlling the level of nitrite and/or nitrate in the system such that it is at (and remains at), or is close to (or remains close to), a nitrite and/or nitrate setpoint can thus be important from this point view also in EBPR methods.

In some embodiments, an organic carbon source is added (i.e. exogenously added) to the water in the anaerobic step. This may be added (or dosed) into influent water or directly into a reactor during the anaerobic step (e.g. into an anaerobic chamber or zone of a reactor). Such a carbon source should of course be a suitable energy source for microorganisms. Examples of such carbon sources include methanol, glycol, acetic acid, or the like, or hydrolysates of sludge (which would include many types organic carbon molecules including for example volatile fatty acids).

In some embodiments, COD level and/or BOD level may be determined (typically in the untreated water, e.g. influent water). Means for determining COD level and BOD levels are known in the art.

In some embodiments, an organic carbon source may be added to the water of the anaerobic step, or the supply (or dosing) of an organic carbon source to the water of the anaerobic step may be regulated or adjusted (e.g. increased or decreased), dependent on the COD and/or BOD level in the water to be treated (e.g. influent water). A COD and/or BOD setpoint may be used in some embodiments to control the supply of carbon.

In other embodiments, no carbon source is added (i.e. no carbon source is exogenously added). In some embodiments, there is sufficient carbon source in the influent water to meet the requirements of the microorganisms in the biofilm (so no exogenously added carbon source is required).

In some embodiments, the concentration (or level) of nitrogen in the form of ammonium (e.g. the NH₄—N concentration) in the water is determined (e.g. the concentration of ammonium in the water to be treated (untreated water, e.g. influent water) and/or in treated water (e.g. effluent water)). A sensor or detector is typically used for determining the concentration of nitrogen in the form of ammonium (e.g. the NH₄—N concentration).

Methods of the present invention are enhanced biological phosphorus removal (EBPR) methods. As described elsewhere herein, the level of nitrite and/or nitrate detected in the water in or after aerated step (ii) is used to control the amount of oxygen supplied in aerated step (ii) and this is useful, for example in the operational efficiency of EBPR methods.

However, in EBPR methods, the level of nitrite and/or nitrate in the water in the aerated step can be useful not only for controlling the amount of oxygen supplied in the aerated step, but also for controlling other parameters, for example for controlling the influent flow of the water to be treated into a reactor in which the method is being carried out, and/or for determining whether or not, and the extent to which (i.e. what amount of), a carbon source is added to (or supplied to) the water of the anaerobic step (e.g. into an influent water stream or directly into the anaerobic zone).

If there is a low level of nitrite and/or nitrate in the water (or no or essentially no nitrite and/or nitrate in the water) in the aerated step (e.g. substantially below the nitrite and/or nitrate setpoint concentration, e.g. <50%, <25%, <10%, <5% or 0% or essentially 0% of the nitrite and/or nitrate setpoint concentration) at a DO concentration (e.g. ≥1 mg/l, ≥2 mg/l, 3 mg/l, ≥4 mg/l, ≥5 mg/l, or ≥10 mg/l) at which a higher nitrite and/or nitrate concentration would be expected in the water, that may be indicative that the carbon load (amount of organic carbon) in the water is too high. Without wishing to be bound be theory, if the carbon load in the water is too high, the biofilm may have become dominated (or overrun) by the fast growing HET bacteria in the outer layer of the biofilm in this carbon rich environment, with these HET bacteria consuming all (or essentially all) of the available oxygen; the PAOs may have been outcompeted by the fast growing HETs. If a low(er) level of (or no or essentially no) nitrite and/or nitrate than expected at a given DO concentration is detected then one cannot be certain that the PAOs received enough oxygen for phosphorus (phosphate) uptake. The indicator that the nitrite and/or nitrate detection provides has been lost in this scenario. To rectify this, action may be taken to decrease (or reduce) the carbon load of the water. Again without wishing to be bound by theory, upon a decrease of the carbon load, the proliferation of the fast growing HET bacteria decreases, meaning that oxygen can again reach the deeper parts of the biofilm, including the PAOs and also the nitrifying (N) bacteria which can use the oxygen to generate nitrite and nitrate from ammonium. As methods of the present invention are typically performed in a reactor having an inlet through which influent water (i.e. water to be treated) can be supplied into the reactor (as described elsewhere herein), the carbon load may be reduced by reducing the amount (or rate or flow) of influent water into the reactor. The influent water of course contains organic carbon.

Thus, in some embodiments, methods are performed in a reactor and the amount (or rate or flow) of influent water into the reactor is dependent on the level of nitrite and/or nitrate in the water in the aerated step. In some embodiments, the amount (or rate or flow) of influent water into the reactor is decreased in response to the detection of a low level of nitrite and/or nitrate in the water (or the detection of no or essentially no nitrite and/or nitrate in the water) in the aerated step (e.g. substantially below the nitrite and/or nitrate setpoint concentration, e.g. <50%, <25%, <10%, <5% or 0% or essentially 0% of the nitrite and/or nitrate setpoint concentration) at a DO concentration (e.g. ≥1 mg/l, ≥2 mg/l, ≥3 mg/l, ≥4 mg/l, ≥5 mg/l, or ≥10 mg/l) at which a higher nitrite and/or nitrate concentration would be expected in the water. Purely by way of example, if at maximum (or close to maximum) DO concentration there is low (or no or essentially no) nitrite and/or nitrate, that is indicative that the amount (or rate or flow) of influent water should be decreased.

If there is a high level (or concentration) of nitrite and/or nitrate in the water in or after the aerated step relative to the nitrite and/or nitrate setpoint (e.g. substantially above the nitrite and/or nitrate setpoint level, for example >200%, >300%, >400%, >500%, or more, of the nitrite and/or nitrate setpoint level) at a DO concentration at which a lower nitrite and/or nitrate concentration would typically be expected in the water (e.g. at a DO concentration of <2 mg/l, <1.5 mg/l, <1 mg/l, <0.5 mg/l), that may be indicative that the carbon load (amount of organic carbon) in the water is insufficient for the PAOs for phosphate uptake. In this regard, it may indicate that the PAOs did not take up enough carbon during anaerobic step (i). This may in particular be the case when there is a high level (or concentration) of nitrite and/or nitrate in the water even when minimal oxygen is supplied in aerated step (ii).

Without wishing to be bound be theory, if the organic carbon load in the water is too low, and the PAOs therefore did not take up sufficient organic carbon in the anaerobic step, the PAOs would not be requiring (demanding) the same amount of oxygen in the aerated step that they would require (demand) if they had taken up more (or sufficient) organic carbon in the anaerobic step. Thus, nitrifying (N) bacteria) are able to access the oxygen in the aerated step more readily than they could if the PAOs were demanding oxygen (the PAOs are typically located in an outer layer of the biofilm with respect to the N bacteria). N bacteria typically use CO₂ as a carbon source. In this situation, the PAOs would not be efficiently taking up phosphate from the water in the aerated step. By adding organic carbon, or increasing the supply of organic carbon, to the water of the anaerobic step (e.g. by adding (or supplying or dosing) organic carbon into the water to be treated, for example in the influent water or directly into the anaerobic chamber of a reactor), the PAOs would have more organic carbon available for uptake in the anaerobic step that they could then subsequently use in the aerated step for phosphate uptake. As methods of the present invention are typically performed in a reactor having an inlet through which influent water (i.e. water to be treated) can be supplied into the reactor (as described elsewhere wherein), the organic carbon may added, to the organic carbon supply increased, to the influent water, or alternatively organic carbon may be added, or the supply increased, directly into the anaerobic chamber of a reactor.

Thus, in some embodiments, an organic carbon source is added, or the supply of an organic carbon source is adjusted (e.g. increased), in the water of anaerobic step (i) dependent on the level of nitrite and/or nitrate in the water in the aerated step.

In some embodiments, an organic carbon source is added, or the supply of an organic carbon source is increased, in response to the detection of a high level of nitrite and/or nitrate in the water in the aerated step (e.g. substantially above the nitrite and/or nitrate setpoint level, for example >200%, >300%, >400%, >500%, or more, of the nitrite and/or nitrate setpoint level) at a DO concentration at which a lower nitrite and/or nitrate concentration would typically be expected in the water (e.g. at a DO concentration of <2 mg/l, <1.5 mg/l, <1 mg/l, <0.5 mg/l). Typically, in such embodiments, an organic carbon source is added, or the supply of an organic carbon source is increased, if there is a high level (or concentration) of nitrite and/or nitrate in the water even when minimal oxygen is supplied in aerated step (ii). In some embodiments, an organic carbon source is added, or the supply of an organic carbon source is increased, if the level of nitrite and/or nitrate cannot be reduced (or cannot be significantly reduced) by reducing the DO concentration of the water (e.g. to a minimal DO concentration).

The addition/supply of organic carbon to the anaerobic zone may be monitored and controlled by a COD or BOD sensor (as described elsewhere herein).

In some embodiments, the only requirement is that the level of phosphorus (phosphate) is reduced in the water being treated. Thus, in some embodiments it is not necessary to achieve a significant reduction in the nitrogen level in the water. However, in other cases, it is important that the level of nitrogen is significantly reduced. For example, in some areas, local environmental regulations require that the level of nitrogen in water (e.g. wastewater) being treated is significantly reduced before being discharged to the environment.

In addition to reducing phosphorus (phosphate) levels, methods of the present invention may also operate to additionally remove significant amounts of nitrogen from water being treated. Thus, in some embodiments, methods of the present invention are combined EBPR-nitrogen removal methods (as described elsewhere herein).

As mentioned above, biofilms in accordance with the present invention typically also comprise denitrifying (DN) bacteria, typically in an anoxic part/layer of the biofilm. Nitrite (NO₂) and/or nitrate (NO₃) generated by the nitrifying bacteria can be converted to nitrogen gas (N₂) or nitrous oxide (N₂O) by the denitrifying bacteria. The method may thus operate as a combined EBPR/nitrogen removal method (e.g. a combined EBPR/nitrification-denitrification, e.g. SND—simultaneous nitrification-denitrification method). Denitrifying bacteria can convert nitrate to nitrogen gas (N₂) or nitrous oxide (N₂O), but in some cases nitrite can be converted to nitrogen gas (N₂) or nitrous oxide (N₂O) without the nitrite (NO₂) first being converted to nitrate (NO₃).

The biofilm may be present on (i.e. attached to or present on the surface of) any type of carrier. The skilled person is familiar with biofilm carriers and any suitable carrier may be used.

In some embodiments, a carrier may be a stationary (or immobilized) carrier, for example large drums, or plates, or the walls of a reactor in which the method of the invention is being performed.

However, preferably, biofilm carriers are free flowing carriers that are able to move in the water (i.e. they are not stationary when in use). Such carriers are capable of flowing freely in water. Such carriers can thus provide a moving bed of biofilm. Such carriers are able to flow in the water (e.g. flow entrained in the water) being treated in accordance with methods of the invention. Such free flowing carriers may also be referred to as suspended carriers. Free flowing carriers are suitable for use in a moving bed biofilm reactor (MBBR).

Carriers able to flow in the water are typically highly durable, lightweight and structurally strong.

Biofilm carriers such as free flowing biofilm carriers may be of any suitable material, but typically and preferably they are made of one or more plastics. For example the biofilm carrier may be made of one or more plastics selected from the group consisting of polyethylene (for example high density polyethylene), polypropylene and polyurethane.

Biofilm carriers, e.g. free flowing biofilm carriers, typically have a high surface area per unit of volume, for example at least 200 m²/m³ (e.g. at least 300 m²/m³, at least 400 m²/m³, at least 500 m²/m³, at least 600 m²/m³, at least 700 m²/m³, at least 800 m²/m³, at least 900 m²/m³, or at least 1000 m²/m³, or up to 500 m²/m³, up to 600 m²/m³, up to 700 m²/m³, up to 800 m²/m³, up to 900 m²/m³, up to 1000 m²/m³, or up to 1200 m²/m³). In some embodiments, biofilm carriers may have a surface area per unit of volume of about 200 to 1200 m²/m³, about 200 to 1000 m²/m³, about 200 to 800 m²/m³, about 400 to 1200 m²/m³, about 400 to 1000 m²/m³ or about 400 to 800 m²/m³. Having a high surface area per unit of volume is typically advantageous as it provides large surface area on which the biofilm can grow (and thus a high concentration of biomass per unit volume of the carrier can be achieved). The above references to surface areas are preferably references to protected surface areas.

Biofilm carriers, e.g. free flowing biofilm carriers, may be of any suitable density. Typically, the density of the carrier is close to (preferably just below) the density of water. Thus, in some embodiments, the density of the carriers is around 0.90 to 0.99 g/cm³ (e.g. 0.92-0.97 g/cm³, preferably 0.94-0.96 g/cm³). Free flowing biofilm carriers having such densities are particularly useful as they can be readily suspended in, and thus readily flow in, water being treated.

Biofilm carriers, e.g. free flowing biofilm carriers, may be of any suitable shape, but typically they are substantially ring shaped, and typically they have a high internal surface area. Typical free flowing biofilm carriers comprise passages through which water can flow.

Biofilm carriers, e.g. free flowing biofilm carriers, may be of any suitable size, but typically have a nominal width or diameter of about 5 mm to 50 mm and a nominal height of about 5 mm to 50 mm.

In some embodiments, the biofilm carriers are AnoxKaldnes carriers (Veolia), for example Anox Kaldnes K1 carriers (Veolia) or AnoxKaldnes K3 carriers (Veolia), or are Biowater carriers (Biowater Technology), for example BW15 carriers (Biowater Technology), or are carriers having one or more of the characteristics of such carriers.

In some preferred embodiments, the biofilm carriers are not foam (e.g. not open-cell foam) carriers, not sponge carriers, and are not other types of carriers capable of holding (or retaining) a significant amount of water (i.e. not capable of holding (or retaining) a significant amount of water when they are picked up from (or removed from, or lifted up out of, or transferred from) water in which they have been residing).

Preferred biofilm carriers in accordance with the invention do not hold (or retain) a significant amount of water when they are picked up from (or removed from, or lifted up out of) water in which they have been residing. There could be some small amounts of water present on such carriers when they are picked up from (or removed from, or lifted up out of, or transferred from) water in which they have been residing (e.g. water droplets clinging to the carrier or water within the biofilm on the carrier), but such small amounts are not considered herein to be held or retained water (and alternatively viewed they may be considered as de minimis or insignificant amounts).

Typically of course, methods of enhanced biological phosphorus removal from water by a biofilm are performed in a reactor. Any suitable reactor may be used.

A typical reactor comprises at least one chamber for holding water, at least one inlet and at least one outlet. Said inlet is an inlet through which influent water (i.e. water to be treated) can be supplied into the reactor. Said outlet is an outlet through which effluent water (i.e. treated water) can be discharged from the reactor. Said reactor is typically also provided with a means for supplying oxygen (typically in the form of air) to at least one chamber (e.g. a blower, bubble diffuser or the like), one or more valves through which oxygen (typically in the form of air) can enter at least one chamber, a means (e.g. a sensor or detector) for determining the concentration of nitrite and/or nitrate in water, a means (e.g. a sensor or detector) for determining the concentration of dissolved oxygen (DO) in water and one or more controllers for regulating the amount of oxygen (typically in the form of air) entering the chamber.

Thus, in some embodiments, methods of enhanced biological phosphorus removal from water by a biofilm are performed in a reactor system, said system comprising a reactor, a means for supplying oxygen (typically in the form of air) to the chamber (e.g. a blower, bubble diffuser or the like), one or more valves through which oxygen (typically in the form of air) can enter the chamber, a means (e.g. a sensor or detector) for determining the concentration of nitrite and/or nitrate in water, a means (e.g. a sensor or detector) for determining the concentration of dissolved oxygen (DO) in water and one or more controllers for regulating the amount of oxygen (typically in the form of air) entering the chamber.

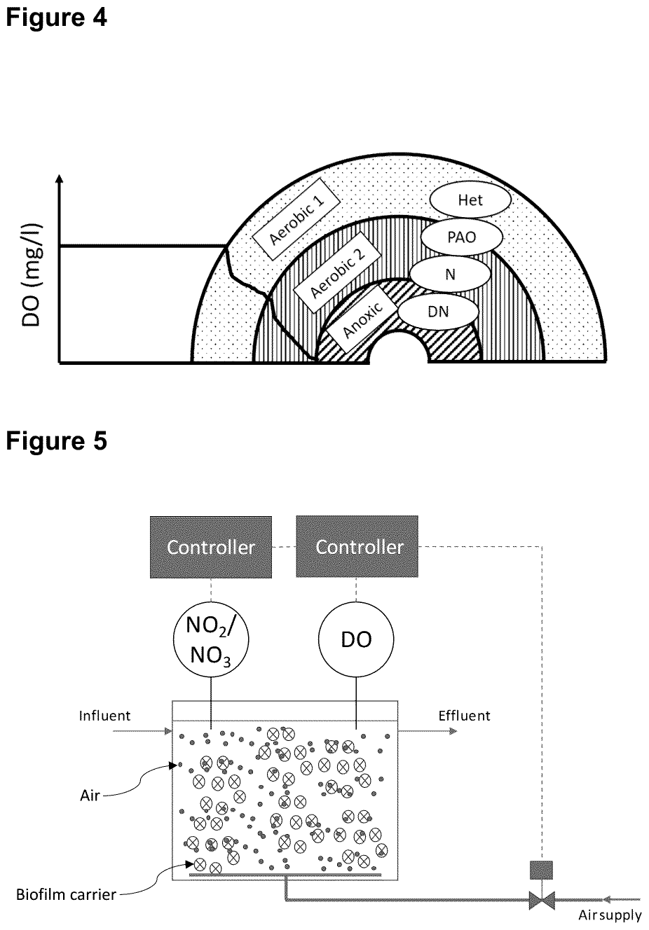

In methods in accordance with the present invention performed in a reactor, biofilms and water are present in the reactor chamber and thus, alternatively viewed, in some embodiments, methods of enhanced biological phosphorus removal from water by a biofilm are performed in a reactor system, said system comprising a reactor, a means for supplying oxygen (typically in the form of air) to the chamber (e.g. a blower, bubble diffuser or the like), one or more valves through which oxygen (typically in the form of air) can enter the chamber, a means (e.g. a sensor or detector) for determining the concentration of nitrite and/or nitrate in water, a means (e.g. a sensor or detector) for determining the concentration of dissolved oxygen (DO) in water and one or more controllers for regulating the amount of oxygen (typically in the form of air) entering the chamber, a biofilm and water. FIG. 5 depicts one such reactor system schematically.

Preferably, the reactor comprises at least two chambers (or at least two zones). In some such embodiments, the reactor comprises at least one chamber (or at least one zone) for exposing a biofilm therein to anaerobic conditions and at least one chamber (or at least one zone) for exposing a biofilm therein to aerated conditions. A chamber (or zone) for exposing a biofilm therein to anaerobic conditions may be conveniently referred to herein as an anaerobic chamber (or anaerobic zone). A chamber (or zone) for exposing a biofilm therein to aerated conditions may be conveniently referred to herein as an aerated (or aerobic) chamber (or an aerated or aerobic zone). In some embodiments, particularly in the case of continuous biofilm methods in accordance with the present invention in which biofilm carriers circulate continuously through a reactor, there is no complete physical boundary between the anaerobic chamber and the aerated chamber and as such in this case it can be more appropriate to refer to a reactor (particularly when in use) having at least two zones (i.e. an anaerobic zone and an aerated zone). Thus, in some embodiments, the at least two chambers are not completely physically separated (water and biofilm carriers can move (or flow) from the anaerobic zone to the aerated zone). Alternatively viewed, in some embodiments, the at least two chambers are in fluid communication with each other. In some embodiments, there is a wall between the anaerobic chamber (or zone) and the aerated chamber (or zone), said wall having a hole through which the water and carriers can flow from the anaerobic chamber (zone) to the aerated chamber (zone). Free-flowing biofilm carriers may be transferred from the (e.g. end of the) anaerobic chamber (zone) to the (e.g. start of the) aerobic chamber (zone) in any appropriate manner, but typically and preferably the free-flowing biofilm carriers simply flow from the anaerobic chamber to the aerobic chamber entrained in the water (so typically no mechanical transfer is required). Free-flowing biofilm carriers may be transferred from the (e.g. end of the) aerobic chamber (zone) back into to the (e.g. start of the) anaerobic chamber (zone) in any appropriate manner, but preferably the free-flowing biofilm carriers are transferred from the (e.g. end of the) aerobic chamber (zone) back into to the (e.g. start of the) anaerobic chamber (zone) by a mechanical device (and preferably this may be done without significant transfer of water back into the anaerobic chamber, e.g. as described elsewhere herein). In methods performed in a reactor having an anaerobic chamber (zone) and an aerobic chamber (zone), water (e.g. water with free-flowing biofilm carriers therein) typically does not flow from the (e.g. end of the) aerobic chamber (zone) back into the (e.g. start of the) anaerobic chamber (zone). Thus, such a reactor is typically configured such that water (e.g. water with free-flowing biofilm carriers entrained therein) does not flow from the (e.g. end of the) aerobic chamber (zone) back into the (e.g. start of the) anaerobic chamber (zone). As mentioned above, preferably free-flowing biofilm carriers are transferred from the (e.g. end of the) aerobic chamber (zone) back into to the (e.g. start of the) anaerobic chamber (zone) by a mechanical device.

A reactor that comprises at least two chambers (or at least two zones) is typically also provided with a means for supplying oxygen (typically in the form of air) to at least one chamber (e.g. a blower, bubble diffuser or the like), one or more valves through which oxygen (typically in the form of air) can enter the at least one chamber, a means (e.g. a sensor or detector) for determining the concentration of nitrite and/or nitrate in water, a means (e.g. a sensor or detector) for determining the concentration of dissolved oxygen (DO) in water and one or more controllers for regulating the amount of oxygen (typically in the form of air) entering the at least one chamber.

Thus, in some embodiments, methods of enhanced biological phosphorus removal from water by a biofilm are performed in a reactor system, said system comprising a reactor comprising at least two chambers or zones (anaerobic chamber/zone and aerated chamber/zone) and, a means for supplying oxygen (typically in the form of air) to the aerated zone (e.g. a blower, bubble diffuser or the like), one or more valves through which oxygen (typically in the form of air) can enter the aerated chamber (or zone), a means (e.g. a sensor or detector) for determining the concentration of nitrite and/or nitrate in water in the aerated chamber (or zone), a means (e.g. a sensor or detector) for determining the concentration of dissolved oxygen (DO) in water in the aerated chamber (or zone) and one or more controllers for regulating the amount of oxygen (typically in the form of air) entering the aerated chamber (or zone).

In methods in accordance with the present invention performed in a reactor, biofilms and water are present in the reactor chamber and thus, alternatively viewed, in some embodiments, methods of enhanced biological phosphorus removal from water by a biofilm are performed in a reactor system, said system comprising a reactor comprising at least two chambers or zones (anaerobic chamber/zone and aerated chamber/zone) and, a means for supplying oxygen (typically in the form of air) to the aerated zone (e.g. a blower, bubble diffuser or the like), one or more valves through which oxygen (typically in the form of air) can enter the aerated chamber (or zone), a means (e.g. a sensor or detector) for determining the concentration of nitrite and/or nitrate in water in the aerated chamber (or zone), a means (e.g. a sensor or detector) for determining the concentration of dissolved oxygen (DO) in water in the aerated chamber (or zone) and one or more controllers for regulating the amount of oxygen (typically in the form of air) entering the aerated chamber (or zone), a biofilm and water.

In some embodiments, chambers (or zones) of a reactor may be sub-divided by one or more walls into multiple sub-chambers (or sub-zones), with such walls having openings to allow free-flowing biofilm carriers to flow, entrained in the water, from one sub-chamber to the next. Sub-dividing chambers into multiple sub-chambers can improve the plug flow of water with carriers entrained therein through a reactor.

In embodiments in which there are multiple sub-chambers (or sub-zones) of an aerated chamber (or aerated zone), a means for supplying oxygen (typically in the form of air) to the aerated zone (e.g. a blower, bubble diffuser, or the like) and/or one or more valves through which oxygen (typically in the form of air) can enter the aerated chamber (or zone) may be provided to more than one (e.g. 2, 3, 4, or more, or even all) of said sub-chambers (or sub-zones). In some embodiments, a means (e.g. a sensor or detector) for determining the concentration of dissolved oxygen (DO) may be provided in one or more sub-chambers (or sub-zones). In some embodiments, a means (e.g. a sensor or detector) for determining the concentration of nitrite and/or nitrate may be provided in one or more sub-chambers (or sub-zones).

In some embodiments of the present invention in which there are multiple sub-chambers (or sub-zones) of an aerated chamber (or aerated zone), the amount (or rate or flow) of oxygen (preferably in the form of air) supplied in the aerated step may be different in different sub-chambers. In some embodiments, the amount (or rate or flow) of oxygen (preferably in the form of air) supplied to a given sub-chamber may be dependent on the level or concentration of (i) nitrate and/or nitrite, (ii) DO, or (iii) the concentration of (i) and (ii) in that sub-chamber.

In some embodiments, the reactor (for example in an anaerobic chamber/zone thereof) may be provided with one or more mixers (or stirrers) to mechanically mix the carriers in the water. Typically such mixers operate in the anaerobic step of methods of the invention.

In some preferred embodiments, a reactor further comprises a means for transferring biofilm carriers from the (e.g. typically the end of the) aerated chamber (aerated zone) back into the (e.g. typically the start of the) anaerobic chamber (anaerobic zone). Said means (or device) may be any appropriate transport device or conveyor, for example a conveyor belt, transport screw, elevator, or the like. In preferred embodiments, the transfer of the biofilm carriers from the (e.g. typically the end of the) the aerobic chamber back into the (e.g. typically the start of the) anaerobic chamber is done without significant transfer of water (or without transfer of water). Thus, in preferred embodiments the reactor further comprises a means for transferring biofilm carriers from the (e.g. typically the end of the) the aerated chamber (aerated zone) back into the (e.g. typically the start of the) anaerobic chamber (anaerobic zone) without significant transfer of water. Such means thus allow water to drain off (from the biofilm carriers) during the transfer.

Typically, the outlet of the reactor is covered with means for retaining free-flowing biofilm carriers in the reactor (i.e. a means that prevents free-flowing biofilm carriers from being discharged from the reactor through the outlet in effluent water). Such retaining means include screens, or sieves, or the like.

A particularly preferred type of reactor is a Moving Bed Biofilm Reactor (MBBR).

In a particularly preferred embodiment, the reactor (and reactor system) is substantially as depicted in FIG. 1 herein.

In some embodiments, the reactor is further provided with a means (e.g. a sensor or detector) for determining the concentration of nitrogen in the form of ammonium (e.g. the NH₄—N concentration). Said means (e.g. a sensor or detector) for determining the concentration of nitrogen in the form of ammonium is typically for determining the concentration of nitrogen in the form of ammonium in the influent water and/or in the effluent water. Thus, the reactor may be provided with a means (e.g. a sensor or detector) for determining the concentration of nitrogen in the form of ammonium (e.g. the NH₄—N concentration) in the influent (i.e. untreated) water and/or a means (e.g. a sensor or detector) for determining the concentration of nitrogen in the form of ammonium (e.g. the NH₄—N concentration) in the effluent (i.e. treated) water. Suitable means for determining the concentration of nitrogen in the form of ammonium (e.g. the NH₄—N concentration) are well-known to the skilled person.

In some embodiments, the reactor is further provided with a means (e.g. a sensor or detector) for determining the concentration of carbon. As the skilled person will be aware, typically in this field a concentration of COD (or filtered COD) or BOD could be determined, i.e. COD or BOD measurement(s) could be made. COD stands for chemical oxygen demand. BOD stands for biochemical oxygen demand. COD and BOD measurements are well known in the field of water treatment and environmental chemistry. Measuring COD is a well-known way to quantify the amount (or concentration of) organic compounds (including organic carbon compounds). COD provides an indicative measure of the amount of oxygen that can be consumed by reactions in a measured solution. BOD provides a measure of the amount of dissolved oxygen needed (i.e. demanded) by aerobic biological organisms to break down organic material present in a given water sample at certain temperature over a specific time period. COD and BOD measurements do not provide a direct measurement of the amount of carbon in the water but may be used as an indicator thereof. Thus, alternatively viewed the reactor may be further provided with a means (e.g. a sensor or detector) for determining (or measuring) COD or BOD. Said means (e.g. a sensor or detector) for determining the concentration of carbon (alternatively viewed a means for determining COD or BOD) is typically for determining the concentration of carbon (or COD or BOD) in the influent water, but the concentration (or COD or BOD) in the effluent water could also be determined if desired. Thus, the reactor may be provided with a means (e.g. a sensor or detector) for determining the concentration of carbon (or COD or BOD) in the influent water and/or a means (e.g. a sensor or detector) for determining the concentration of carbon (or COD or BOD) in the effluent water. The reactor may be provided with a means (e.g. a sensor or detector) for determining COD in the influent water and/or a means (e.g. a sensor or detector) for determining the COD in the effluent water. The reactor may be provided with a means (e.g. a sensor or detector) for determining BOD in the influent water and/or a means (e.g. a sensor or detector) for determining the BOD in the effluent water. Suitable means are well-known to a skilled person, for example suitable sensors for determining COD or BOD levels include sensors of the Spectro::lyser range (e.g. Spectro::lyser V3) of S::can Messtechnik GmbH (Austria).

The means for determining the concentrations of the various substances (e.g. nitrogen in the form of ammonium, DO, nitrate, nitrite or carbon) may be operated constantly in some embodiments. Thus, in some embodiments there may be constant monitoring (or surveying or measuring or determining) of the concentrations of these substances. The means for determining the concentrations of the various substances may be in-line means (e.g. in-line sensors or in-line detectors or in-line probes or in-line analysers). “In-line” sensors, etc., or “in-line” concentrations may also be referred to as “on-line” sensors or “on-line” concentrations, respectively. As the skilled person will be aware, in-line sensors are typically placed in a process vessel or stream of flowing material and can conduct automatic (and optionally continuous) measurements.

Methods of EBPR may be batch methods or may be continuous methods. Continuous methods of EBPR are preferred.

In batch methods, a single volume of water (i.e. a single or discrete batch of water) is treated (i.e. one volume of water is treated per batch). In batch biofilm EBPR methods, the biofilm in the batch of water being treated is exposed to anaerobic conditions and then subsequently exposed to aerated conditions thereby removing phosphorus from the batch of water. After the exposure to aerated conditions, the water (i.e. the treated batch of water) can be discharged (typically through an outlet of the reactor in which the batch method is being performed). Batch methods are not typically preferred as for each batch of water they require filling a reactor (with water to be treated) and then draining (treated water) from the reactor, which can be time consuming.

As mentioned above, continuous EBPR methods are preferred. In continuous methods, there is a continuous supply of untreated water (i.e. water to be treated) and a continuous discharge of treated water (i.e. water from which biological phosphorus has been removed). Put another way, in continuous EBPR methods performed in reactors in accordance with present invention, there is a continuous influent stream of water to be treated entering the reactor and a continuous effluent stream water that has been treated being discharged from the reactor. In continuous EBPR methods, the anaerobic step and the aerated step are performed in separate chambers of the reactor, with the anaerobic step being performed prior to the aerated step.

In preferred continuous EBPR methods of the present invention, the biofilms are present on biofilm carriers (free flowing biofilm carriers) and at the end of the aerated step (i.e. at the end of the aerated chamber) said carriers are transferred back into the anaerobic chamber. Thus, preferably, the biofilm carriers circulate around the reactor, repeatedly passing from the (e.g. end of the) anaerobic chamber into the (e.g. start of the) aerated chamber and then from the (e.g. end of the) aerated chamber back into the anaerobic chamber, etc. The transfer from the aerated chamber back into the anaerobic chamber may be done by any appropriate transport device or conveyor, for example a conveyor belt, transport screw, or the like. In some preferred embodiments, the transfer of biofilm carriers from the (e.g. the end of the) aerated chamber back into the anaerobic chamber is done without significant transfer of water (or without transfer of water).

Without wishing to be bound by theory, it is believed that not transferring a significant amount of water from the aerated chamber to the anaerobic chamber of the reactor is advantageous for the following reasons. The water in the aerated chamber is, by definition, oxygenated (i.e. contains dissolved oxygen) and it also contains nitrites/nitrates. Thus, if water is transferred from the aerated chamber to the anaerobic chamber oxygen and nitrites/nitrates will be introduced into the anaerobic chamber. This could disrupt the anaerobic nature of the anaerobic chamber. Not transferring a significant amount of water from the aerated chamber to the anaerobic chamber of the reactor is advantageous as it prevents inhibition of the anaerobic zone by oxygen and nitrate.

In this regard, as discussed elsewhere herein, PAOs on the biofilm carriers that move through the various chambers (or zones) of the reactor can take up carbon (carbon is an energy source) without the need for oxygen or nitrate/nitrite and thus can take up carbon in the anaerobic zone. Most other bacteria in the biofilm on the carriers (e.g. denitrifying bacteria) cannot take up carbon in these conditions, and thus in the anaerobic chamber the PAOs (which of course have the important role of taking up phosphorus once they subsequently enter the aerated chamber) have a selective advantage over other bacteria in the biofilm on the carriers. It can thus be important to keep the anaerobic chamber anaerobic in order to give the PAOs preferential access to the carbon in the water to be treated. If significant amounts of water are transferred from the aerated chamber back to the anaerobic chamber it could introduce significant amounts of oxygen and nitrites/nitrates into the anaerobic chamber which other (i.e. other non-PAO) organisms could use to take up carbon in the anaerobic chamber, and the PAOs' selective advantage could be diminished. In addition, returning water from the aerated chamber to the anaerobic chamber could also reduce efficiency, as it represents the return of treated water to a zone of untreated water. Treated water from the aerated chamber transferred back to the anaerobic chamber would take up space (volume) in the anaerobic zone and thus could lower the retention time for untreated water in the anaerobic chamber.

Methods of the invention may any have suitable hydraulic retention time (HRT, also known as hydraulic residence time). HRT is a measure of the average length of time that water is held in a reactor. The skilled person in the field is familiar with, and readily able to determine, suitable retention times. HRTs may be, by way of example, at least 1 hour, or at least 2 hours, or at least 3 hours, or at least 4 hours, or at least 5 hours, or at least 12 hours, or at least 24 hours. HRTs may, for example, be up to 2 hours, or up to 3 hours, or up to 4 hours, or up to 5 hours or up to 12 hours, or up to 24 hours, or up to 48 hours. HRTs may, for example, be in the order of one or a few hours to 2 days, for example 2-24 hours, or 5-24 hours, or 12-24 hours, or 2-12 hours, or 5-12 hours, or 12-24 hours. Other exemplary HRTs are 2-5 hours, e.g. 3-4 hours. Any appropriate length of time of exposure to anaerobic conditions and any appropriate length of time of exposure to aerobic conditions may be used, and the skilled person is readily able to select suitable lengths of time. The total HRT may in some embodiments be equally split between the anaerobic step and the aerated step (i.e. the length of time of exposure to anaerobic conditions may be the same (or essentially the same) as the length of time of the exposure to aerated conditions), but in other embodiments the total HRT may not be equally split, e.g. the length of time of the exposure to anaerobic conditions may be shorter than the length of time of exposure to aerated conditions, or the length of time of the exposure to anaerobic conditions may be longer than the length of time of exposure to aerated conditions. In some embodiments, the duration of the anaerobic step represents 10%-80% of the total HRT (e.g. 10%-70%, 10%-60%, 10%-50%, 10%-40%, 10%-30%, 10%-20%, 20%-80%, 20%-70%, 20%-60%, 20%-50%, 20%-40%, 20%-30%, 50%-80%, 50%-70% or 50%-60%), with the duration of the aerated step representing the rest of the total HRT. In some embodiments, the duration of the aerated step represents 10%-80% of the total HRT (e.g. 10%-70%, 10%-60%, 10%-50%, 10%-40%, 10%-30%, 10%-20%, 20%-80%, 20%-70%, 20%-60%, 20%-50%, 20%-40%, 20%-30%, 50%-80%, 50%-70% or 50%-60%), with the duration of the anaerobic step representing the rest of the total HRT. In some preferred embodiments, the length of time of the exposure to anaerobic conditions is shorter than the length of time of exposure to aerated conditions. In an exemplary embodiment, the duration of the anaerobic step represents about 30% of the total HRT and the duration of the aerated step represents about 70% of the total HRT.

In some embodiments, said biofilm is present on biofilm carriers and the filling ratio of biofilm carriers is between 1% and 100%, preferably between 30% to 75% (e.g. 50% to 65%, for example 55% or 60%), of the wet volume of the reactor.

The term EBPR refers to the “removal” of phosphorus, but as the skilled person will understand, this does not necessarily mean that all of the phosphorus is removed from the water. EBPR methods of the present invention include methods that reduce the level (or concentration or amount) of phosphorus in the water by any meaningful or significant amount (i.e. as compared to the level of phosphorus in the untreated water). Phosphorus/phosphate levels (or concentrations) in the context of the present invention are typically measured and discussed in terms of PO₄—P (as discussed elsewhere herein).

By way of example, in some embodiments, EBPR methods may result in at least a 50% reduction in the concentration of phosphorus (PO₄—P) in the water as compared to the concentration of phosphorus (PO₄—P) in the untreated water (e.g. influent water), preferably at least a 60% reduction, at least a 70% reduction, at least a 80% reduction, at least a 90% reduction, at least a 95% reduction, at least a 96% reduction, at least a 97% reduction, at least a 98% reduction, at least a 99% reduction, or even a complete (100%) reduction. In some preferred embodiments, EBPR methods may result in at least a 90% reduction, more preferably at least a 95% or at least a 98% reduction in the concentration of phosphorus (PO₄—P) in the water as compared to the concentration of phosphorus in the untreated water (e.g. influent water). Alternatively viewed, in some embodiments, water that has been treated in accordance with an EBPR method of the present invention may have <50% of the phosphorus (PO₄—P) concentration as compared to the concentration of phosphorus (PO₄—P) in the water prior to the treatment, preferably 540%, 530%, 520%, 510%, 55%, 54%, 53%, 52%, 51% (or even 0%). In some preferred embodiments, water that has been treated in accordance with an EBPR method of the present invention may have <10% of the phosphorus (PO₄—P) concentration as compared to the concentration of phosphorus in the water prior to the treatment, preferably <5% or <2%.

In some embodiments, the phosphorus (PO₄—P) concentration in water that has been treated (or processed) by an EBPR method of the invention (e.g. effluent water) has a concentration of ≤1 mg/l PO₄—P, preferably ≤0.5 mg/l PO₄—P, ≤0.4 mg/l PO₄—P, <0.3 mg/l PO₄—P, <0.2 mg/l PO₄—P or ≤0.1 mg/l PO₄—P. In some embodiments, the phosphorus (PO₄—P) concentration in water that has been treated (or processed) by an EBPR method of the invention (e.g. effluent water) has a concentration of ≤0.2 mg/l PO₄—P or ≤0.1 mg/l PO₄—P.

Phosphorus concentration (PO₄—P) may be as determined using any appropriate method and the skilled person is familiar with suitable methods. For example, one method for determining PO₄—P concentration is by filtering “grab” samples of the water through a filter (e.g. a 1-micron filter), and then analysing the filtered water with a phosphate test kit (e.g. from Merck Millipore) and a spectrophotometer (e.g. a Merck Spectroquant NOVA 60 Spectrophotometer). PO₄—P considers only the phosphorus of the phosphate. Put another way, PO₄—P is the phosphorus content of the phosphate.

Methods of the present invention may thus further comprise a step of determining the phosphate (PO₄—P) level (or concentration) in the water that has been treated (after aerated step (ii)), or may further comprise a step of determining the phosphate (PO₄—P) level (or concentration) in the water that has been treated (after aerated step (ii), e.g. in effluent water) and a step of determining the phosphate (PO₄—P) level (or concentration) in the water before it has been treated (before anaerobic step (i), e.g. in influent water).

In some embodiments, the only requirement is that the level of phosphorus (phosphate) is reduced in the treated water. Thus, in some embodiments it is not necessary to achieve a significant reduction in the nitrogen level in the water. However, in some other embodiments, it is important that the level of nitrogen is significantly reduced. For example, in some areas, local environmental regulations require that the level of nitrogen in water (e.g. wastewater) being treated is significantly reduced.

In addition to reducing phosphorus (phosphate) levels, methods of the present invention may also operate to additionally remove significant amounts of nitrogen from water being treated (i.e. addition to removing phosphorus from the water). “Removal” of nitrogen of course does not necessarily mean that all of the nitrogen is removed, but includes any meaningful or significant decrease (i.e. as compared to the level of in the untreated water), e.g. as discussed elsewhere herein.

Methods in accordance with the present invention typically also remove (or reduce) nitrogen from the water (i.e. reduce the concentration (or level or amount) of nitrogen in the water). Thus, some methods of the present invention may thus be considered combined EBPR and nitrogen removal methods. The nitrogen removal process may comprise simultaneous nitrification/denitrification (SND), e.g. as discussed elsewhere herein. Thus, methods of the invention may be combined EBPR and SND methods (or combined EBPR-SND methods). Thus, methods of the invention may be operated as combined EBPR and SND methods (or combined EBPR-SND methods). Simultaneous nitrification and denitrification (SND) combines the activities of nitrifying (N) and denitrifying (DN) bacteria in a single reactor. The skilled person is familiar with the concept of nitrification-denitrification, e.g. SND. Briefly, N bacteria typically obtain carbon from CO₂ and use oxygen (i.e. they require aerated/aerobic conditions) to convert ammonium to nitrite and nitrate (which may together be referred to as NOx), and DN bacteria use inorganic carbon and convert nitrate and nitrite to nitrogen gas or nitrous oxide under anoxic conditions. N bacteria function in oxic conditions and DN bacteria function in anoxic conditions.

In some preferred embodiments of combined EBPR and nitrogen removal methods of the invention, there is no nitrogen removal, or no significant amount (or proportion) or no substantial amount (or proportion) of nitrogen removal, by the anammox process (or mechanism). Thus, in some preferred embodiments of combined EBPR and nitrogen removal methods of the invention, there is no nitrogen removal, or no significant amount (or proportion) or no substantial amount (or proportion) of nitrogen removal, by anammox bacteria. Thus, in some embodiments, the biofilm does not comprise, or does not contain a significant (or substantial) number of, or does not contain a significant (or substantial) proportion of, anammox bacteria. Thus, in some embodiments, a combined EBPR and nitrogen removal method of the invention is not a combined EBPR-anammox method, i.e. is not operated as a combined EBPR and anammox method. The skilled person is familiar with anammox methods and anammox bacteria. Anammox is an abbreviation for anaerobic ammonium oxidation. Anammox bacteria convert ammonium and nitrite into diatomic nitrogen.

In combined EBPR and nitrogen removal methods, the method may further further comprise a step of determining the ammonium level (NH₄—N) level (or concentration) in the water that has been treated (after aerated step (ii)), or further comprise a step of determining the ammonium (NH₄—N) level (or concentration) in the water that has been treated (after aerated step (ii), e.g. in effluent water) and a step of determining the ammonium (NH₄—N) level (or concentration) in the water before it has been treated (before anaerobic step (i), e.g. in influent water). By comparing the NH₄—N level before treatment to the NH₄—N level after treatment, it can be determined whether or not, or the extent to which, ammonium has been removed. Optionally, the method may further comprise a step of determining the ammonium (NH₄—N) level (or concentration) in aerated step (ii). In some embodiments, nitrate (NO₃—N) level and nitrite (NO₂—N) level may also be determined in the water that has been treated (after aerated step (ii)) and/or in the water before it has been treated (before anaerobic step (i), e.g. in influent water).

As described elsewhere herein, the nitrogen to be removed is typically nitrogen in the form of ammonium (e.g. in influent water). Nitrogen removal is typically achieved by the action of nitrifying (N)/denitrifying (DN) bacteria, as described elsewhere herein.

Methods of the present invention may reduce the level (or concentration or amount) of nitrogen in the form of ammonium in the water by any meaningful or significant amount (i.e. as compared to the level of ammonium in the untreated, e.g. influent water). By way of example, in some embodiments, methods may result in at least a 20% reduction in the concentration of ammonium (NH₄—N) in the water as compared to the concentration of ammonium (NH₄—N) in the untreated water (e.g. influent water), preferably at least a 30% reduction, at least a 40% reduction, at least a 50% reduction, at least a 60% reduction, at least a 70% reduction, at least a 80% reduction or at least a 90% reduction. In some preferred embodiments, methods may result in at least a 20% reduction, more preferably at least a 30% or at least a 40% reduction in the concentration of ammonium (NH₄—N) in the water as compared to the concentration of ammonium in the untreated water (e.g. influent water). Alternatively viewed, in some embodiments, water that has been treated in accordance with a method of the present invention may have ≤80% of the ammonium (NH₄—N) concentration as compared to the concentration of ammonium (NH₄—N) in the water prior to the treatment, preferably ≤70%, ≤60%, ≤50%, ≤40%, ≤30%, ≤20% or ≤10%. In some preferred embodiments, water that has been treated in accordance with a method of the present invention may have ≤60% of the ammonium (NH₄—N) concentration as compared to the concentration of ammonium in the water prior to the treatment, preferably ≤50%. In some embodiments, the ammonium (NH₄—N) concentration in water that has been treated (or processed) by a method of the invention (e.g. effluent water) has a concentration of ≤50 mg/l NH₄—N, preferably ≤40 mg/l NH₄—N, ≤30 mg/l NH₄—N or ≤20 mg/l NH₄—N. Ammonium concentration (NH₄—N) may be as determined using any appropriate method and the skilled person is familiar with suitable methods. For example, online NH₄—N sensors (detectors/meters) may be used, and the skilled person is familiar with such sensors. NH₄—N considers only the nitrogen of the ammonium. Put another way, NH₄—N is the nitrogen content of the ammonium.

Although measuring the ammonium level before (e.g. in the influent water) and after treatment (e.g. in the effluent water) provides a measure of the amount of ammonium removed from the water (the difference between the ammonium level before and after treatment indicates the amount of ammonium removed), the amount of ammonium derived nitrogen (NH₄—N) that has been completely removed from the water cannot be determined based such ammonium levels alone, as some of the ammonium derived nitrogen may have been nitrified to form nitrite and/or nitrate, but not then subsequently denitrified to nitrogen gas or nitrous oxide.

Thus, in some embodiments, nitrite (NO₂—N) and nitrate (NO₃—N) levels in the water in or after the aerated step (e.g. in the effluent water) are added to (i.e. summed with) the ammonium (NH₄—N) level after the aerated step (e.g. in the effluent water), and the sum of said ammonium level (NH₄—N), nitrite level (NO₂—N) and nitrate level (NO₃—N) is compared with the ammonium (NH₄—N) level in the water before it was treated (before anaerobic step (i), e.g. in influent water). The difference between said sum of nitrite (NO₂—N), nitrate (NO₃—N) and ammonium (NH₄—N) levels (i.e. NO₂—N+NO₃—N+NH₄—N) and the ammonium (NH₄—N) level in the water before treatment indicates (or provides a measurement of) the amount of ammonium derived nitrogen (NH₄—N) that has been completely removed from the water (i.e. converted from ammonium to nitrogen gas or nitrous oxide).

In some embodiments, methods may result in at least a 20% reduction in the ammonium derived nitrogen level in the water after the aerated step (i.e. in treated water e.g. effluent water) as compared to the ammonium derived nitrogen level in the untreated water (e.g. influent water), as determined by comparing the ammonium (NH₄—N) level in the untreated water to the sum of the ammonium (NH₄—N), nitrite (NO₃—N) and (NO₂—N) level in the treated water. Preferably, there is at least a 30% reduction, at least a 40% reduction, at least a 50% reduction, at least a 60% reduction, at least a 70% reduction, at least a 80% reduction or at least a 90% reduction. In some preferred embodiments, methods may result in at least a 20% reduction, more preferably at least a 30% or at least a 40% reduction. Alternatively viewed, in some embodiments, water that has been treated in accordance with a method of the present invention may have ≤80% of the ammonium derived nitrogen level as compared to the ammonium derived nitrogen level in the water prior to the treatment, preferably ≤70%, ≤60%, ≤50%, ≤40%, ≤30%, ≤20% or ≤10% (as determined as mentioned above). In some embodiments, water that has been treated in accordance with a method of the present invention may have ≤60% of the nitrogen level as compared to the level in the water prior to the treatment (as determined as mentioned above), preferably ≤50%.

In some embodiments, methods may result in at least a 20% reduction in the total inorganic nitrogen level in the water as compared to the total inorganic nitrogen level in the untreated water (e.g. influent water), preferably at least a 30% reduction, at least a 40% reduction, at least a 50% reduction, at least a 60% reduction, at least a 70% reduction, at least a 80% reduction or at least a 90% reduction. In some preferred embodiments, methods may result in at least a 20% reduction, more preferably at least a 30% or at least a 40% reduction. Alternatively viewed, in some embodiments, water that has been treated in accordance with a method of the present invention may have ≤80% of the total inorganic nitrogen level as compared to the total inorganic nitrogen level in the water prior to the treatment, preferably ≤70%, ≤60%, ≤≤0%, ≤40%, ≤30%, ≤20% or ≤10%. In some embodiments, water that has been treated in accordance with a method of the present invention may have ≤60% total inorganic nitrogen level as compared to the level in the water prior to the treatment, preferably ≤50%.

In some embodiments, a desired level of nitrogen removal could be obtained by modulating one or more parameters to control the method. For example, nitrogen removal could be increased by increasing the oxygen supply in the aerated step (to provide increased nitrification of ammonium by N bacteria) and/or by adding an organic carbon source, or increasing the supply of organic carbon in the anaerobic step, to provide increased denitrification by DN bacteria (e.g. DNPAOs).

As described elsewhere herein, in EBPR methods of the present invention the level of nitrite and/or nitrate in or after aerated step (ii) is used to control the amount of oxygen supplied to aerated step (ii). In combined EBPR-nitrogen removal methods, the level of nitrite and/or nitrate detected in or after aerated step (ii) can also be very useful as a marker (or indicator) for the control the amount of nitrogen removal.

Thus, in some embodiments, the level of nitrite and/or nitrate detected in or after aerated step (ii) is also used to control nitrogen removal.

Without wishing to be bound by theory, in cases where good nitrogen removal is desired, if the level of ammonium (NH₄—N) in the treated water (after aerated step (ii), e.g. in effluent water) is significantly reduced (e.g. reduced by ≥60%, ≥70%, ≥80%, ≥90%, or ≥95%, as compared to the level of ammonium (NH₄—N) in the untreated water (e.g. influent water) and the nitrite and/or nitrate level in the water of the aerated step is high (e.g. higher than a setpoint for nitrite and/or nitrate, for example >200%, >300%, >400%, >500%, or more, of the nitrite and/or nitrate setpoint level), then this would indicate good nitrification but low (or poor) denitrification. In this situation, it may be beneficial to add an organic carbon source to the water of the anaerobic step, or to increase the supply of organic carbon to the water of anaerobic step (i). DN bacteria (e.g. DNPAOs) can take up and store organic carbon in the anaerobic step, for subsequent use in the aerated step, where they can denitrify nitrite and nitrate. Thus, by adding, or increasing, the supply of an organic carbon source in this situation, denitrification (and thus nitrogen removal) can be improved.

Thus, in some embodiments, when the level of nitrite and/or nitrate in the water in or after aerated step (ii) is high (typically high with respect to a setpoint for nitrite and/or nitrate) and the level of ammonium (NH₄—N) in the treated water (after aerated step (ii), e.g. in effluent water) is significantly reduced, an organic carbon source is added to the water of anaerobic step (i), or the supply of an organic carbon source to the water of anaerobic step (i) is increased.

The “water” to which methods of the present invention may be applied (i.e. water to be treated in accordance with the invention) can be any water comprising phosphorus. Typically, the water to be treated in accordance with the invention will have a concentration (or level or amount) of phosphorus that needs to be reduced (i.e. that is in need of reduction), for example in order to reduce phosphorus to an environmentally acceptable (or environmentally safe) concentration. The skilled person is familiar with what are environmentally acceptable (or environmentally safe) concentrations of phosphorus, and there may be local environmental regulations in this regard. Water (i.e. water to be treated in accordance with a method of the invention) will also comprise nitrogen (e.g. in the form of ammonium). Any phosphorus (phosphate) and nitrogen (ammonium) laden water may be treated in accordance with the present invention. In some embodiments, the water (e.g. influent) to be treated in accordance with a method of the present invention has a concentration of phosphorus (PO₄—P) of at least 1 mg/l (PO₄—P), at least 2 mg/l (PO₄—P), at least 3 mg/l (PO₄—P), at least 4 mg/l (PO₄—P) or at least 5 mg/l (PO₄—P).

In some embodiments, the “water” to which methods of the present invention may be applied (i.e. water to be treated in accordance with the invention) is wastewater, for example municipal wastewater or industrial waste water (or a combination of municipal and industrial wastewater). Municipal wastewater is preferred in some embodiments. In some other embodiments, the “water” is fish farm water.

Typically and preferably, prior to treatment in accordance with a method of the invention (e.g. prior to entering a reactor), water (e.g. raw waste water) is subjected to a pre-treatment step. The pre-treatment may be by a mechanical means (e.g. a screen) to remove large objects such as plastic waste, fabrics and the like. The pre-treatment may also include a step of removing sand and/or grease (or oil). Depending on the quality of and/or origin of the water to be treated, sedimentation or fine screening may also be performed as part of a pre-treatment.

In (or during) the anaerobic step of methods of the present invention, there is no oxygen supplied (i.e. no exogenous oxygen supplied) to the water. In the anaerobic step the conditions are thus anaerobic, with all (or substantially all) of the microorganisms in the biofilm being subjected to (or exposed to) anaerobic conditions during the anaerobic step. Subjecting (or exposing) microorganisms (e.g. PAOs) to anaerobic step is important in the context of EBPR methods, as discussed elsewhere herein.

In (or during) the anaerobic step the water is typically mixed (or stirred or agitated), typically by mechanical means such as one or more mixers or stirrers.

In (or during) the aerated step, oxygen (typically in the form of air) is supplied to water to provide aerated conditions. This step may also be considered an aerobic step (to provide aerobic conditions). In the aerated step, aerobic conditions are provided, with at least some of the microorganisms in the biofilm being subjected to (or exposed to) aerobic conditions. However, even during the aerated step (aerobic step) some microorganisms in the biofilm are not typically subjected to (or exposed to) aerobic conditions, e.g. microorganisms in the deeper layers of the biofilm (i.e. further way from the water) may be subjected to anoxic or even anaerobic conditions during the aerated step, e.g. as discussed elsewhere herein. Subjecting (or exposing) microorganisms (e.g. PAOs) to aerobic conditions is important in the context of EPBR methods, as discussed elsewhere herein.

The oxygen supplied in the aerated step is typically supplied in the form of air. Air may be supplied by any suitable means, e.g. a bubble diffusor or blower or the like. Where an aerated chamber (or zone) of a reactor is sub-divided into multiple sub-chambers (or multiple sub-zones), oxygen (e.g. in the form of air) is supplied to at least one of the sub-chambers, preferably more than one (or even all) of the sub-chambers.

The oxygen (e.g. in the form of air) is preferably provided continuously during the aerated step. Of course, a continuous supply of oxygen (e.g. in the form of air) does not mean that the amount of oxygen supplied is constant (or uniform) during the aerated step. On the contrary, as described elsewhere herein, the amount of oxygen supplied in the aerated step will depend on the level of nitrite and/or nitrate detected in the water. In embodiments in which there is a continuous supply of oxygen (e.g. in the form of air), the supply may be considered continuous but variable (or continuous but varied, or continuous but varying). Thus, preferably the oxygen supply is not toggled between being “on” and “off”, but rather is continuously “on” with the amount of oxygen being supplied at a given time varying (dependent on the level of nitrite and/or nitrate detected in the water).

In other embodiments, the oxygen (e.g. in the form of air) may be provided (or supplied) non-continuously during the aerated step. In some embodiments, in the aerated step there may be a plurality of periods (distinct periods) in which oxygen (e.g. in the form of air) is supplied (or delivered) to the water, with said periods being separated by (or interrupted by or interspersed with) periods in which no oxygen is supplied (or delivered) to the water. Thus, in some embodiments, the oxygen supply may be toggled between being “on” and “off”.

In (or during), the aerated step, the water is also typically mixed (or agitated). This may be by mechanical means such as one or more mixers or stirrers, but typically mechanical means or mixing are not employed as they are not required for mixing to be achieved. Typically, the oxygen (e.g. in the form of air) supplied in the aerated step (e.g. via a bubble diffusor or blower or the like) will bubble through the water with the bubbles causing mixing of the water.

The amount (or rate or flow) of air (and thus oxygen) supplied in the aerated step may, in some embodiments, be conveniently measured in m³/h (or any other convenient units). Purely by way of example, in some embodiments, the amount (or rate or flow) of air (and thus oxygen) supplied in the aerated step is in the region of 500-2000 m³/h, but of course the amount will depend on multiple factors e.g. the size of reactor and, importantly in the context of the present invention, the level (or concentration) of nitrite and/or nitrate detected.

Preferred methods of the present invention do not comprise (i.e. do not include a step of) recycling of activated sludge. The skilled person is familiar with activated sludge methods of water treatment. In activated sludge methods, a portion of the activated sludge (biomass) is separated from the effluent (treated) water (in a sludge separation process, e.g. in a settling tank) and then is recycled into (i.e. back into) the reactor in order to maintain the microbiological culture (biomass) in the reactor. This is typically known as “sludge recycling” (or “sludge return” or “sludge recirculation” or “biomass recycling”). Thus, in preferred methods of the present invention, there is no sludge recycling.

In preferred methods of present invention the MLSS (mixed liquor suspended solids) concentration (i.e. in the water undergoing treatment or in treated (effluent) water) may be in the order of 50-400 mg MLSS/I, for example in the order of 150-250 mg MLSS/I. Thus, in some embodiments, the MLSS concentration may be <400 mg MLSS/I or <300 mg MLSS/I. Mixed liquor suspended solids (MLSS) is a well-known term and concept in the field of water treatment, and is the concentration of solids (which includes microorganisms) suspended in the water during the water treatment. The skilled person is familiar with methods suitable for determining MLSS concentrations. In preferred biofilm methods of the present invention the MLSS concentration of the water (i.e. the water undergoing treatment) is relatively low (e.g. as compared to activated sludge methods), as the vast majority of the microorganisms are present in the biofilms on the carriers (i.e. immobilized on the carriers) as opposed to being freely suspended (e.g. in flocs) in the water, as is the case in activated sludge methods. In activated sludge methods a typical MLSS (mixed liquor suspended solids) concentration is 2000-8000 mg MLSS/I.

Sometimes in this field, reference may be made simply to the concentration of suspended solids (SS) instead of referring to the concentration of mixed liquor suspended solids (MLSS). Thus, in preferred embodiments of the present invention the SS concentration (i.e. in the water undergoing treatment or in treated (effluent) water) may be in the order of 50-400 mg SS/I, for example in the order of 150-250 mg SS/I. Thus, in some embodiments, the SS concentration may be ≤400 mg SS/I or ≤300 mg SS/I. SS (or MLSS) concentration may be determined by any appropriate method, and the skilled person is familiar with appropriate methods. For example, in some methods of determining a SS (or MLSS) concentration, a (e.g. 50 ml) sample (typically a well-mixed sample) of water (water undergoing treatment or treated (effluent) water) is filtered through a weighed standard filter (e.g. glass-fiber filter) and the residue left on the filter is dried to a constant weight (e.g. at a temperature of 105° C.), and the increase in weight of the filter represents the total suspended solids in the sample, and this can be used to calculate the concentration of suspended solids in the water (e.g. in mg/l).

In some embodiments, the above SS (or MLSS) concentrations may be average (e.g. mean) concentrations over multiple samples.

In some preferred methods of the present invention, at least 95% (preferably at least 96%, at least 97%, at least 98% or at least 99%) of the total microorganisms (biomass) in the water-biofilm carrier mixture are present on (or attached to) the carriers. Thus, in some preferred methods of the present invention, 5% or less, 4% or less, 3% or less, 2% or less or 1% or less of the total microorganisms (biomass) in the water-biofilm carrier mixture are suspended in the water (i.e. freely suspended in the water or not attached biofilm carriers).

In another aspect, the invention provides a water treatment system configured to operate a method of the present invention. The discussion elsewhere herein in relation to preferred features and properties of other aspects of the invention may be applied, mutatis mutandis, to this aspect of the invention.

In another aspect, the invention provides a water treatment system configured to operate a method of the present invention, said system comprising
(i) a reactor
(ii) at least one means for supplying oxygen (typically in the form of air) to said reactor;
(iii) one or more valves through which oxygen (typically in the form of air) can enter said reactor;
(iv) at least one means for determining the concentration of nitrite and/or nitrate in water;
(v) at least one means for determining the concentration of dissolved oxygen (DO) in water; and
(vi) one or more controllers for regulating the amount of oxygen (typically in the form of air) entering the reactor.
   The discussion elsewhere herein in relation to preferred features and properties of other aspects of the invention (e.g. preferred features of the reactor) may be applied, mutatis mutandis, to this aspect of the invention.

In another aspect, the invention provides a water treatment system for enhanced biological phosphorus removal from water by a biofilm, said system comprising
(i) a reactor
(ii) at least one means for supplying oxygen (typically in the form of air) to said reactor;
(iii) one or more valves through which oxygen (typically in the form of air) can enter said reactor;
(iv) at least one means for determining the concentration (or level) of nitrite and/or nitrate in water;
(v) at least one means for determining the concentration (or level) of dissolved oxygen (DO) in water; and
(vi) one or more controllers configured to regulate (or control) the amount (or rate or flow) of oxygen (typically in the form of air) entering the reactor, said regulation being dependent on the concentration (or level) of nitrite and/or nitrate determined by the means of (iv).
   The discussion elsewhere herein in relation to preferred features and properties of other aspects of the invention (e.g. preferred features of the reactor) may be applied, mutatis mutandis, to this aspect of the invention.

In another aspect, the invention provides a water treatment system configured to operate a method of the present invention, said system comprising
(i) a reactor
(ii) at least one means for supplying oxygen (typically in the form of air) to said reactor;
(iii) one or more valves through which oxygen (typically in the form of air) can enter said reactor;
(iv) at least one means for determining the concentration of nitrite and/or nitrate in water;
(v) at least one means for determining the concentration of dissolved oxygen (DO) in water;
(vi) at least one first controller configured to (a) receive the concentration (concentration value) of DO from at least one means (v), (b) compare said concentration (concentration value) to a DO-setpoint (setpoint concentration), (c) adjust the amount of oxygen supplied to said reactor to adjust the DO concentration of the water to the DO-setpoint concentration, (d) receive a signal from at least one second controller and adjust the DO setpoint based on the signal received; and
(vii) at least one second controller configured to (a) receive the concentration (concentration value) of nitrite and/or nitrate from at least one means (iv), (b) compare said concentration (concentration value) to a nitrite and/or nitrate setpoint (setpoint concentration), and (c) signal to at least one first controller (vi) if the concentration of nitrite and/or nitrate is different from the setpoint.
   The discussion elsewhere herein in relation to preferred features and properties of other aspects of the invention (e.g. preferred features of the reactor) may be applied, mutatis mutandis, to this aspect of the invention.

Systems of the present invention may further comprise one or more further components, e.g. other components described herein. For example, systems of the present invention may further comprise at least one means for determining the level of COD, at least one means for determining the level of BOD, at least one means for supplying an organic carbon source to the reactor, and/or at least one means for determining the level (or concentration) of ammonium (NH₄).

The components of the system may be arranged in any manner appropriate for performance of a method of the invention, and particular arrangements (or setups) may be as described elsewhere herein in connection with other aspects and embodiments of the invention.

In another aspect, the invention provides a water treatment system configured to operate a method of the present invention, said system comprising
(i) a reactor
(ii) at least one means for supplying oxygen (typically in the form of air) to water in said reactor;
(iii) one or more valves through which oxygen (typically in the form of air) can enter said reactor;
(iv) at least one means for determining the concentration of nitrite and/or nitrate in water;
(v) at least one means for determining the concentration of dissolved oxygen (DO) in water;
(vi) one or more controllers for regulating the amount of oxygen (typically in the form of air) entering the reactor;
(vii) a biofilm; and
(viii) water
   The discussion elsewhere herein in relation to preferred features and properties of other aspects of the invention (e.g. preferred features of the reactor, preferred biofilm carriers, etc.) may be applied, mutatis mutandis, to this aspect of the invention.

In some embodiments of water treatment systems of the invention, the reactor comprises at least two chambers (or zones), at least one of which is for exposing a biofilm on free flowing biofilm carriers therein to anaerobic conditions (which may be referred to as an anaerobic chamber or zone) and at least one of which is for exposing a biofilm on free flowing biofilm carriers therein to aerated conditions (which may be referred to as an anaerobic chamber or zone). In some such embodiments, the system may further comprise a means for transferring said free flowing biofilm carriers (having biofilms thereon) from the (end of the) aerated chamber back into the (the start of the) anaerobic chamber. Such means include, for example, any appropriate transport device or conveyor, for example a conveyor belt, transport screw, elevator, or the like.

In another aspect, the invention provides an apparatus (e.g. a reactor) configured to operate a method of the present invention. The discussion elsewhere herein in relation to preferred features and properties of other aspects of the invention may be applied, mutatis mutandis, to this aspect of the invention.

In another aspect, the method provides a water treatment plant configured to operate a method of the present invention. The discussion elsewhere herein in relation to preferred features and properties of other aspects of the invention may be applied, mutatis mutandis, to this aspect of the invention.

Alternatively viewed, the present invention provides a method for enhanced biological phosphorus removal from water by a biofilm, said method comprising:
(i) an anaerobic step in which said biofilm is subjected to anaerobic conditions;
(ii) an aerated step in which said biofilm is subjected to aerated conditions by supplying oxygen to the water;
(iii) detecting the level of nitrite and/or nitrate in the water in or after aerated step (ii);
(iv) adjusting the amount of oxygen supplied in aerated step (ii) depending on level of nitrite and/or nitrate detected.
   The discussion elsewhere herein in relation to preferred features and properties of other aspects of the invention may be applied, mutatis mutandis, to this aspect of the invention.

Alternatively viewed, the present invention provides a method for reducing the PO₄—P concentration in water using a biofilm, said method comprising:
(i) an anaerobic step in which said biofilm is subjected to anaerobic conditions;
(ii) an aerated step in which said biofilm is subjected to aerated conditions by supplying oxygen to the water;
(iii) detecting the level of nitrite and/or nitrate in the water in or after aerated step (ii);
wherein the amount of oxygen supplied in aerated step (ii) depends on the level of nitrite and/or nitrate detected.
   The discussion elsewhere herein in relation to preferred features and properties of other aspects of the invention may be applied, mutatis mutandis, to this aspect of the invention.

In another aspect, the present invention provides a method for enhanced biological phosphorus removal from water by a biofilm, said method comprising:
(i) an anaerobic step in which said biofilm is subjected to anaerobic conditions;
(ii) an aerated step in which said biofilm is subjected to aerated conditions by supplying oxygen to the water, said aerated step having (i.e. being operated with) a dissolved oxygen (DO)-setpoint;
(iii) detecting the level of nitrite and/or nitrate in the water in or after aerated step (ii);
wherein a DO-setpoint in aerated step (ii) is adjusted (or varied or altered) dependent on the level of nitrite and/or nitrate detected.
   The discussion elsewhere herein in relation to preferred features and properties of other aspects of the invention may be applied, mutatis mutandis, to this aspect of the invention.

In another aspect, the present invention provides a method for enhanced biological phosphorus removal from water by a biofilm, said method comprising:
(i) an anaerobic step in which said biofilm is subjected to anaerobic conditions;
(ii) an aerated step in which said biofilm is subjected to aerated conditions by supplying oxygen to the water, said aerated step having (i.e. being operated with) a dissolved oxygen (DO)-setpoint;
(iii) detecting the level of nitrite and/or nitrate in the water in or after aerated step (ii) and comparing said detected level to a nitrite and/or nitrate setpoint;
wherein said DO-setpoint in aerated step (ii) is adjusted (or varied or altered) dependent on the level of nitrite and/or nitrate detected relative to the nitrite and/or nitrate setpoint.

In another aspect, the present invention provides a continuous method for enhanced biological phosphorus removal from water by a biofilm that is present on free flowing biofilm carriers in said water, wherein said method is carried out in a Moving Bed Biofilm Reactor, said method comprising:
(i) an anaerobic step in which said biofilm on said carriers is subjected to anaerobic conditions, wherein said anaerobic step is carried out in an anaerobic zone of a reactor;
(ii) transfer of said carriers from the end of said anaerobic zone of said reactor to an aerated zone of said reactor;
(iii) an aerated step in which said biofilm on said carriers is subjected to aerated conditions by supplying oxygen to the water, wherein said step is carried out in said aerated zone of said reactor;
(iv) detecting the level of nitrite and/or nitrate in the water in or after aerated step (iii);
(v) transferring said biofilm carriers from the end of said aerated zone back into said anaerobic zone (preferably without significant transfer of water);
wherein the amount of oxygen supplied in aerated step (iii) depends on the level of nitrite and/or nitrate detected.
   The discussion elsewhere herein in relation to preferred features and properties of other aspects of the invention may be applied, mutatis mutandis, to this aspect of the invention.

In another aspect, the present invention provides a biofilm method of enhanced biological phosphorus removal from water, said method comprising controlling (or modulating or adjusting) a DO-setpoint for said water, said method comprising:
(i) an anaerobic step in which said biofilm is subjected to anaerobic conditions;
(ii) an aerated step in which said biofilm is subjected to aerated conditions by supplying an amount of oxygen to the water to aim to provide (or to provide) a DO concentration in said water that is a equivalent to (or essentially equivalent to) a DO-setpoint concentration;
(iii) detecting the level (or concentration) of nitrite and/or nitrate in the water in or after aerated step (ii);
wherein the DO-setpoint in the aerated step is adjusted based on (or in response to, or dependent on) the level (or concentration) of nitrite and/or nitrate detected.
   The discussion elsewhere herein in relation to preferred features and properties of other aspects of the invention may be applied, mutatis mutandis, to this aspect of the invention.

In another aspect, the present invention provides a method for the removal of phosphorus and nitrogen from water by a biofilm, said method comprising:
(i) an anaerobic step in which said biofilm is subjected to anaerobic conditions;
(ii) an aerated step in which said biofilm is subjected to aerated conditions by supplying oxygen to the water;
(iii) detecting the level of nitrite and/or nitrate in the water in or after aerated step (ii);
wherein the amount of oxygen supplied in aerated step (ii) depends on the level of nitrite and/or nitrate detected.
   The discussion elsewhere herein in relation to preferred features and properties of other aspects of the invention may be applied, mutatis mutandis, to this aspect of the invention.

In another aspect, the method provides a method of maintaining, in an aqueous environment, a biofilm that simultaneously comprises (i) an aerobic region comprising nitrifying bacteria that convert ammonium to nitrite and/or nitrate and (ii) an anoxic region comprising denitrifying bacteria that denitrify nitrite and/or nitrate to nitrogen gas or nitrous oxide, said method comprising:
(i) an aerated step in which said biofilm is subjected to aerated conditions by continually supplying oxygen to the aqueous environment;
(ii) determining the level of nitrite and/or nitrate in the aerated biofilm-containing aqueous environment;
(iii) adjusting the amount of oxygen supplied in aerated step (i) depending on the level of nitrite and/or nitrate determined.
   The discussion elsewhere herein in relation to preferred features and properties of other aspects of the invention may be applied, mutatis mutandis, to this aspect of the invention.

In another aspect, the present invention provides a method for enhanced biological phosphorus removal from water by a biofilm, said method comprising:
(i) an anaerobic step in which said biofilm is subjected to anaerobic conditions;
(ii) an aerated step in which said biofilm is subjected to aerated conditions by supplying oxygen to the water;
(iii) detecting the level of nitrite and/or nitrate in the water in or after aerated step (ii);
wherein the amount of oxygen supplied in aerated step (ii) is dependent on the level of nitrite and/or nitrate detected,
wherein the level of DO is detected in aerated step (ii) by at least one DO-sensor, said detected level is compared to a DO-setpoint by at least one first controller and said oxygen supply in the aerated step is adjusted if necessary by said at least one first controller such that the DO level in the water in aerated step (ii) is adjusted to the DO-setpoint level, and
wherein, the level of nitrite and/or nitrate is detected in or after aerated step (ii) by at least one nitrite and/or nitrate-sensor, said detected level of nitrite and/or nitrate is compared to a nitrite and/or nitrate-setpoint by at least one second controller, and if the level of nitrite and/or nitrate is different from the nitrite and/or nitrate setpoint, said at least one second controller signals to at least one first controller (or to its respective first controller or respective first controllers), instructing (or causing) said at least one first controller (or respective first controller or respective first controllers) to adjust the DO-setpoint. The discussion elsewhere herein in relation to preferred features and properties of other aspects of the invention may be applied, mutatis mutandis, to this aspect of the invention.

For example, in some embodiments of this aspect of the invention, when an increase in the nitrite and/or nitrate concentration in the water in or after aerated step (ii) relative to the nitrite and/or nitrate setpoint is determined by said at least one second controller, said at least one second controller signals to at least one first controller instructing (or causing) said at least one first controller to decrease the DO-setpoint (thereby the oxygen supply to the water is decreased). This would lead to the decrease in nitrite and/or nitrate concentration in the water. In some embodiments, when a decrease in the nitrite and/or nitrate concentration in the water in or after aerated step (ii) relative to the nitrite and/or nitrate setpoint is determined by said at least one second controller, said at least one second controller signals to at least one first controller instructing (or causing) said at least one first controller to increase the DO-setpoint (thereby the oxygen supply to the water is increased). This would lead to the increase in nitrite and/or nitrate concentration in the water.

In another aspect, the present invention provides the use of the level (or amount or concentration) of nitrite and/or nitrate in water to which oxygen (e.g. in the form of air) is being supplied as a marker (or indicator) that PAOs in a biofilm in said water have received (or have access to) sufficient oxygen to effectively take up phosphorus (typically in the form of phosphate) from said water. The discussion elsewhere herein in relation to preferred features and properties of other aspects of the invention may be applied, mutatis mutandis, to this aspect of the invention.

Where the terms “comprise”, “comprises”, “has” or “having”, or other equivalent terms are used herein, then in some more specific embodiments these terms include the term “consists of” or “consists essentially of”, or other equivalent terms.

The invention will now be further described in the following non-limiting Examples with reference to the following drawings:

FIG. 1: A schematic depiction of the MBBR-reactor setup used in Example 1 described herein. The influent is the influent wastewater (i.e. water that is to be treated). The effluent is the effluent (i.e. treated) wastewater, i.e. the water that has been treated. The open circles represent air (air bubbles). Thus, the sub-chambers of the MBBR containing these open circles together define the aerated chamber (i.e. the zone in which the aerated step of the method takes place). The sub-chambers lacking these open circles together define the anaerobic chamber (the zone in which the anaerobic step of the method takes place). The cartwheels represent biofilm carriers having biofilms thereon. The circles containing the term “DO” represent DO (dissolved oxygen) sensors. The circle containing the term “NO₂/NO₃” represents a sensor for detecting nitrite and/or nitrate level. The bow-tie shapes represent valves. The arrow on the conveyor depicts the transfer of the biofilm carriers from the final aerated sub-chamber back into the first anaerobic sub-chamber. The stirrers in the anaerobic chamber are for the mechanical mixing of the biofilm carriers and the water. The controller labelled C1 receives the DO level measurements from the DO sensors and can adjust the DO-setpoint in response to a signal to do so from the controller labelled C2. The controller labelled C2 can receive the nitrite and/or nitrate level measurements from the sensor for detecting nitrite and/or nitrate level and compare this level to a nitrite and/or nitrate setpoint and communicates with controller C1 to cause controller C1 to adjust the DO-setpoint (increase or decrease) if the nitrite and/or nitrate level is different from the nitrite and/or nitrate setpoint. Adjustment of the DO-setpoint adjusts the amount of air being supplied into the MBBR.

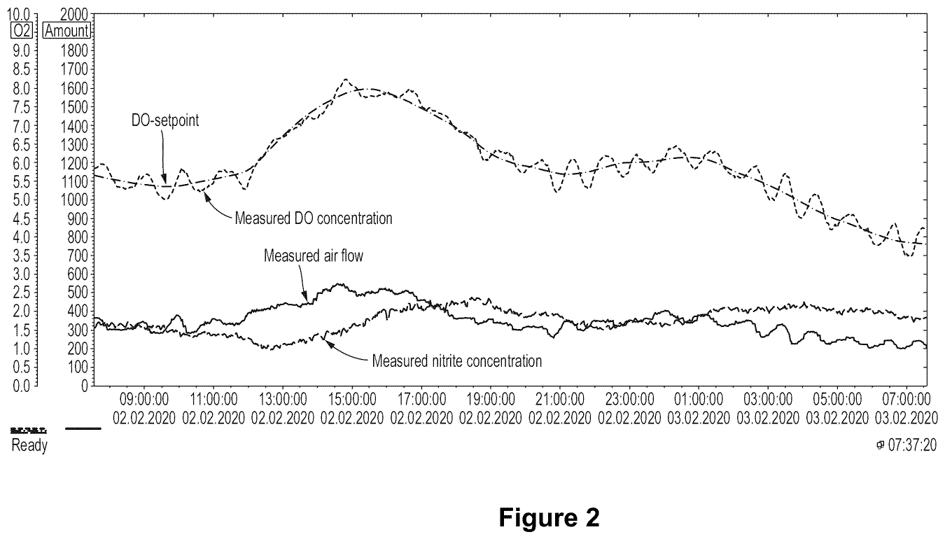

FIG. 2: Graph showing a 24-hour period of operation of the method described in Experimental Example 1, which was operated with an MBBR setup as shown schematically in FIG. 1. The DO-setpoint, measured DO concentration and measured nitrite concentration are all in mg/l (the scale for which is on the left-hand y-axis). The measured air flow (measured air supply/amount) is m³/h (the scale for which is on the right-hand y-axis).

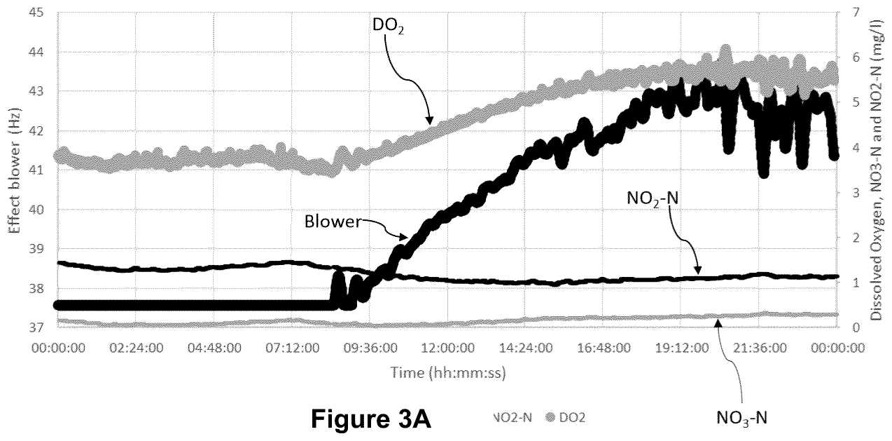

FIG. 3: (A) Graph showing measurements from the aerated chamber of the bioreactor during a 24-hour period of operation of the method described in Experimental Example 2. The measured DO₂ concentration (DO₂, also referred to simply as DO, dissolved oxygen), measured nitrite concentration (NO₂—N) and measured nitrate concentration (NO₃—N) are all in mg/l. The power of the blower (which supplied air and thus oxygen to the aerated chamber) is given in Hz. (B) Graph showing influent NH₄—N concentration, effluent NH₄—N concentration, influent PO₄—P concentration and effluent PO₄—P concentrations during a 24-hour period of operation of the method described in Experimental Example 2 (the same 24 hour period of operation to which FIG. 3A relates). All concentrations are given in mg/l. The dashed line depicts a concentration of 0.1 mg/l PO₄—P.

FIG. 4: Schematic depiction of structuring (layering) of a biofilm in aerated conditions in wastewater, with different DO-concentrations in different layers of the biofilm structure.

FIG. 5: A schematic depiction of an MBBR-reactor setup in accordance with the invention. The influent is the influent wastewater (i.e. water that is to be treated). The effluent is the effluent (i.e. treated) wastewater, i.e. the water that has been treated. The dots represent air (air bubbles). The cartwheels represent biofilm carriers having biofilms thereon. The circle containing the term “DO” represents a DO (dissolved oxygen) sensor. The circle containing the term “NO₂/NO₃” represents nitrite and nitrate sensors. The bow-tie shape represents a valve.

### EXPERIMENTAL EXAMPLES

### Example 1

### Method

Described below is experimental testing of a method for enhanced biological phosphorus removal from water by a biofilm in accordance with the present invention. This exemplified method is a continuous method. The water (i.e. influent water) was municipal wastewater at the Hias wastewater treatment plant in Norway, which is received from four municipalities in Hedmark county.

This method has been demonstrated in a full-scale municipal Moving Bed Biofilm Reactor, in which biofilm carriers colonized with biofilms were present in the water, and the biofilm carriers (AnoxKaldnes K3 (Veolia)) moved through the reactor from the anaerobic chamber to the aerated chamber. AnoxKaldnes K3 biofilm carriers are plastic carriers. The filling ratio used was 55%. The biofilm carriers were then transferred from the aerated chamber (final sub-chamber thereof) back to the anaerobic chamber (first sub-chamber thereof) via a conveyor belt. Thus, there is a continuous cycling of the biofilm carriers. When the biofilm carriers were transferred from the aerated chamber back into the anaerobic chamber there was no significant transfer of water from the aerated chamber back into the anaerobic chamber. The anaerobic chamber and the aerated chamber of the reactor were each sub-divided by walls into multiple sub-chambers, the walls of course having openings to allow the carriers to flow, entrained in the water, from one sub-chamber to the next. The anaerobic chamber contained stirrers to mechanically mix the carriers in the water. In the aerated chamber, air was continuously (but variably) supplied by a bubble diffuser (or blower) and the bubbles mixed the carriers in the water. The influent wastewater flowed into the anaerobic chamber (the first sub-chamber thereof). The effluent (treated) water flowed out of the aerated chamber (final sub-chamber thereof). The aerated chamber of the reactor was provided with an in-line sensor for detecting the concentration of nitrite (NO₂—N) and nitrate (NO₃—N), and multiple sensors for detecting the concentration of DO (dissolved oxygen) were provided (as shown on FIG. 1). For the avoidance of any doubt, the enhanced biological phosphorus removal method described in this experimental example is not an activated sludge method; there is no recycling of sludge (no sludge return). In this experiment, in samples taken from the effluent water there was an average of 250 mg/l of suspended solids (SS). To measure the SS a well-mixed sample of 50 ml of effluent water was filtered through a weighed standard glass-fiber filter and the residue left on the filter was dried to a constant weight at a temperature of 105° C. The increase in weight of the filter represents the total suspended solids of the sample, and was used to calculate the concentration of suspended solids in the water (in mg/l).

A schematic depiction of the MBBR-reactor setup used in this Example is set out in FIG. 1.

In this method, the amount of air (and thus oxygen) supplied to the aerated chamber was adjusted (i.e. increased or decreased), via controllers, depending on of the nitrite concentration detected in the aerated water (i.e. in the water in the aerated chamber). A nitrite-setpoint of 1.5 mg/l was set. The concentration of nitrite was constantly surveyed (measured) by the in-line nitrite sensor. (In this specific experiment the nitrate level was very low (much lower than the nitrite level) and was thus not used as a component of the setpoint concentration (but that is not always the case at other times). When the concentration of nitrite measured by the nitrite sensor fell below the nitrite setpoint, the DO-setpoint was increased and accordingly more air was supplied to the aerated chamber. When the concentration of nitrite measured by the nitrite sensor rose above the nitrite setpoint, the DO-setpoint was decreased and accordingly less air was supplied to the aerated chamber. Thus, the amount of air (and thus oxygen) supplied to the aerated chamber was adjusted depending on the concentration of nitrite detected. Put another way, the DO-setpoint, and accordingly the air supply to the aerated chamber, were varied during the performance of the method, with the variation being a function of the nitrite concentration detected/the fluctuation of the measured nitrite concentration from the nitrite setpoint.

As described elsewhere herein the DO-setpoint can be a DO-setpoint profile, in which there are different DO-setpoints in different aerated sub-chambers of the reactor. This was the case in the study of this experimental example, so with reference to the study of this experimental example the increasing or decreasing of the DO-setpoint means that the DO-setpoint profile was increased or decreased in response to changes in the measured nitrite level relative to the nitrite setpoint. The DO-setpoint profile used was characterised by there being a higher DO-setpoint for sub-chambers at the early part of the aerated chamber as compared to for sub-chambers later in the aerated chamber (i.e. closer to the outlet). In this regard, in the present Example, and with reference to FIG. 1, The DO-setpoint in the first aerated sub-chamber was higher than the DO-setpoint in the fourth aerated sub-chamber, which in turn was higher than the DO-setpoint in the sixth aerated sub-chamber. These different DO-setpoints in different sub-chambers together formed a DO-setpoint profile, which was adjusted (increased or decreased) based on the measured nitrite level relative to the nitrite setpoint.

Each of the DO-sensors in the reactor communicated (or signaled) the DO concentration of the water in the sub-chamber in which the sensor was located to a controller (a PID controller). Thus, in this study, and with reference to FIG. 1, the controller labelled C1 in fact is composed of three separate PID controllers, each operating in response to its respective DO sensor. However, for convenience, FIG. 1 depicts single “controller” receiving the DO concentrations from the three DO sensors. Each of the PID controllers that received the measured DO concentration from its respective DO sensor adjusted the amount of air supplied to the sub-chamber in which its respective DO sensor was located. Of course, not all of the sub-chambers in the reactor have DO sensors (and corresponding PID controllers), so those aerated sub-chambers that did not have a DO sensor were supplied with an amount of air based on the DO-setpoint for an adjacent sub-chamber that did have a DO-sensor. More specifically, and with reference to FIG. 1, the amount or air that was supplied to aerated sub-chamber 2 was based on the measured DO level and DO-setpoint for aerated sub-chamber 1 (which has a DO sensor). The amount or air that was supplied to aerated sub-chamber 3 was based on the measured DO level and DO-setpoint for aerated sub-chamber 4 (which has a DO sensor). The amount or air that was supplied to aerated sub-chambers 5 and 7 was based on the measured DO levels and DO-setpoint for aerated sub-chamber 6 (which has a DO sensor).

### Results

FIG. 2 shows measurements in the aerated step during a 24-hour period of operation of a method as described above, operated with an MBBR setup as shown schematically in FIG. 1. The “DO-setpoint” and the “Measured DO concentration” lines on FIG. 2 shows the “DO-setpoint” and the “Measured DO” concentrations specifically for the first aerated sub-chamber of the reactor (which with reference to FIG. 1 is the fourth sub-chamber counting from the sub-chamber which received the influent water). This trend shown by these lines (curves) was also reflected in the “DO setpoint” and “measured DO concentrations” lines for subsequent aerated sub-chambers, although these lines were shifted down the y-axis due to the lower set DO-setpoints in these later sub-chambers, as described above (data not shown).

In FIG. 2 it can be seen that when the measured nitrite concentration fell below the nitrite setpoint (1.5 mg/l), the DO-setpoint was increased, the measured air supply (measured air flow) was increased and the measured DO concentration in the water increased. The measured nitrite concentration then increased, and when it rose above the nitrite setpoint, the DO-setpoint was decreased, the measured air supply (measured air flow) was decreased and the measured DO concentration in the water decreased.

Operating an analogous method of enhanced biological phosphorus removal at a constant DO-setpoint, in contrast to adjusting/varying the DO-setpoint as per the present method, would, in this example, have more than doubled the air supply demand, from about 200 Nm³/h to about 500 Nm³/h. To supply air to a biological water treatment plant is expensive (the energy costs are high), so a method which can reduce the amount of air supply required offers a distinct advantage.

Of course, it is important that a method of enhanced biological phosphorus removal that has an advantage in terms of the reduced amount of air that needs to be supplied (and thus an advantage in terms of energy use and cost saving) and/or an advantage in terms of providing a stable/more optimally operating biofilm still effectively removes phosphorus from the waste water. The presently exemplified method of enhanced biological phosphorus removal indeed effectively removed phosphorus from the wastewater and the method is at least as effective in terms of removing phosphorus from wastewater as analogous methods that employ a constant DO-setpoint (data not shown). The PO₄—P concentration in the treated water (i.e. effluent water) was in the range 0.1 mg/l to 0.2 mg/l. This is a very low concentration. This PO₄—P concentration in the effluent water was significantly lower than the PO₄—P concentration in the influent water. The PO₄—P concentration in the influent water was around 5 mg/l. The exemplified method also effectively removed (reduced the level of) nitrogen (in the form of ammonium) from the water by around 50% (data not shown).

### Discussion

As described above, the inventors have developed a method for enhanced biological phosphorus removal that achieves excellent biological phosphorus removal from wastewater, and which involves adjusting the DO-setpoint during the aerated step such that the amount of air supplied is only the amount of air that is actually required by the relevant microorganisms in the biofilm. This is in contrast to other analogous methods of enhanced biological phosphorus removal that employ a constant DO-setpoint during the aerated step. This method represents a significant advantage in terms of reduced energy usage associated with the air supply, and thus reduced cost. As described above, central to this advantageous method is the use of measured nitrite and/or nitrate concentration as a parameter to control the amount of air being supplied to the aerated chamber. In this method, only the amount of air (and thus only the amount of oxygen) that is actually required for the relevant biological processes being carried out by the relevant microorganisms in the biofilms is supplied to the aerated chamber. Put another way, in this method, sufficient air (and thus oxygen) is supplied, but in this method only the amount of air that is actually necessary for the relevant biological processes is supplied (i.e. there is no significant superfluous air supplied).

Without wishing to be bound by theory, and as discussed elsewhere herein, the variation in the air supply during the aerated step in the present method controls the oxygen profile within the biofilm. In this regard, and again without wishing to be bound by theory, in a biofilm different types of bacteria live and grow based on what conditions they experience. Therefore, it is possible to obtain bacteria that use oxygen for respiration and bacteria that do not use oxygen in different layers of a biofilm. In biofilms present in wastewater heterotrophic bacteria (HET) are fast growing and take up carbon from the wastewater by using oxygen. In an anaerobic/aerobic process (such as enhanced biological phosphorus removal methods) Phosphate Accumulating Organisms (PAOs), that are slower growing, can use oxygen for phosphate uptake. Nitrifiers (nitrifying bacteria, N) are slow growing bacteria that compete for oxygen with the heterotrophic bacteria and PAOs. During aeration the competition for oxygen is an important parameter in the structuring of the biofilm. The fast growing organisms are situated in the outer part of the biofilm (i.e. the part (or layer) closest to the wastewater) and the slower growing bacteria are situated further into the biofilm. Even further into the biofilm there is no oxygen and the conditions can be anoxic (no (or essentially no) oxygen, but with NO₂ and/or NO₃) or anaerobic (no oxygen and no NO₂ or NO₃). An anoxic layer allows for bacteria that do not use oxygen, but which use NO₂ or NO₃, to live. These bacteria can for instance be denitrifiers (denitrifying bacteria, DN), such as denitrifying PAOs (DNPAOs). This structuring (layering) of a biofilm in aerated conditions in wastewater, with different DO-concentrations in different layers of the biofilm structure, is depicted schematically in FIG. 4.

The nitrifying bacteria (N) normally lose the competition for oxygen to both the heterotrophic bacteria (HET) and PAOs. Thus, if nitrite (NO₂) and/or nitrate (NO₃), which are produced by nitrifying bacteria (N), is detected in the water, this is indicative that both the HET and the PAOs have received enough oxygen, as oxygen has now reached even the slower growing nitrifying bacteria (N) in the biofilm. Thus, of particular relevance to a method of enhanced biological phosphorus removal, the detection of nitrite and/or nitrate in the aerated step (e.g. a concentration above a given setpoint) is indicative that PAOs in the biofilm have received enough oxygen to carry out the process of biological phosphorus removal from the water (i.e. to effect uptake of phosphorus from the water) and that as such the air supply (and thus the oxygen supply) can be decreased. Conversely, if no significant nitrite (NO₂) and/or nitrate (NO₃) is detected in the water (e.g. nitrite and/or nitrate is detected at a concentration that is below a given setpoint), this is indicative that both the HET and the PAOs may not have yet received enough oxygen, as oxygen has not reached the slower growing nitrifying bacteria (N) in the biofilm Thus, of particular relevance to a method of enhanced biological phosphorus removal, a lower (or decreasing) nitrite and/or nitrate (e.g. a concentration below a given setpoint) is indicative that PAOs in the biofilm have not received enough oxygen to carry out the process of biological phosphorus removal from the water and that as such the air supply (and thus the oxygen supply) can be increased.

By detecting (e.g. constantly detecting) the concentration of nitrite and/or nitrate and adjusting the DO-setpoint (if necessary) on the basis of the nitrite and/or nitrate concentration, the present method ensures that the oxygen requirements of the relevant bacteria (e.g. PAOs) are being met, whilst at the same time not supplying more oxygen than is actually needed.

It is also believed that by dynamically controlling the DO-setpoint (and thus as a result the oxygen profile in the biofilm), the biofilm is more stable and more optimal for the purpose of biological phosphate removal by PAOs. For example in this regard, operating with a constant DO-setpoint could mean that more oxygen than is actually required by the PAOs for phosphate uptake is supplied, which in turn would result mean that there could be a high concentration of “superfluous” oxygen (DO) that may be used by nitrifying bacteria to produce high concentrations of nitrites and nitrates. High concentrations of nitrites can inhibit phosphate uptake by PAOs, so it is typically desirable for there not to be high concentrations of nitrites during aeration in an enhanced biological phosphorus removal method.

Having a variable (as opposed to a constant or fixed) DO-setpoint that is dynamically adjusted based on actual oxygen requirements of PAOs, is clearly advantageous, and the present inventors have provided such a method herein.

The local environmental regulations at the Hias wastewater treatment plant do not require that nitrogen is removed from the water before the water is discharged to the environment. However, in addition to achieving good PO₄—P removal by EBPR as described above, the method exemplified in this experimental example also reduced nitrogen levels in the wastewater. In this regard, the sum of the NH₄—N concentration in the effluent (treated) water and the measured NOx-N concentration was significantly less than the NH₄—N concentration of the influent (untreated) water (data not shown). Lab analysis also showed NOx-N levels in the effluent water that were consistent with the NOx-N levels measured in the water in the reactor. These results indicate that a significant amount of ammonium derived nitrogen was completely removed from the system by simultaneous nitrification-denitrification (SND) of ammonium, i.e. indicate that the NOx generated by the nitrifying bacteria was converted to nitrogen gas (N₂) or nitrous oxide (N₂O) by denitrifying bacteria present in the anoxic part (or anoxic layer) of the biofilm. The method can thus operate as a combined EBPR/nitrification-denitrification (e.g. SND) method.

Particularly in the context of methods that effect EBPR and also further comprise the removal of nitrogen from water being treated (e.g. by simultaneous nitrification-denitrification), controlling the DO-profile in the biofilm is important in order to ensure that anoxic conditions are maintained in deeper layers of the biofilm (as anoxic conditions are important for denitrification by denitrifying bacteria); a high nitrite and/or nitrate level can indicate that oxygen is penetrating too far into the biofilm thus disturbing the anoxic conditions.

### Example 2

A further experimental test was carried in a pilot wastewaster treatment plant at the Hias wastewater treatment plant in Norway. The method was analogous to the “full scale” plant method described in Example 1. However, in this Example, AnoxKaldnes K1 biofilm carriers were used. AnoxKaldnes K1 biofilm carriers are plastic carriers. The filling ratio used in this Example was 60%. For the avoidance of any doubt, the enhanced biological phosphorus removal method described in this experimental example is not an activated sludge method; there is no recycling of sludge (no sludge return).

In this experiment, in samples taken from the effluent water there was an average of 250 mg/l of suspended solids (SS). To measure the SS a well-mixed sample of 50 ml of effluent water was filtered through a weighed standard glass-fiber filter and the residue left on the filter was dried to a constant weight at a temperature of 105° C. The increase in weight of the filter represents the total suspended solids of the sample, and was used to calculate the concentration of suspended solids in the water (in mg/l).

The results for a 24 hour period of operation are depicted in FIGS. 3A and 3B. The NOx-setpoint was 1.5 mg/l. In this example, the NOx concentration value was the sum of the NO₂—N concentration and 1.5 times the NO₃—N concentration (i.e. in this example NOx=NO₂—N+1.5×NO₃—N). As shown in FIG. 3A, as the measured NOx concentration falls below the 1.5 mg/l setpoint, the power of the blower (which supplies air and thus oxygen) is increased (as the DO-setpoint was increased in response to the NOx concentration falling below the 1.5 mg/ml setpoint), meaning more air (and thus more oxygen) is supplied. The dissolved oxygen (DO₂, a.k.a. DO) concentration in the water increases accordingly, and the concentration of NO₂—N and NO₃—N ultimately starts to rise. Please note that 37.5 Hz was the minimum power supplied to the blower throughout the aerated step, which explains the constant “blower” flat line on FIG. 3A for the first −8 hours or so. The measurements depicted in FIG. 3A are of course measurements that were taken during an aerated step (in aerated zone of the reactor).

FIG. 3B, shows results for the same 24 hour period of operation as for FIG. 3A, with FIG. 3B showing the NH₄—N concentration in the influent (in) and effluent (out) and showing the PO₄—P concentration in the influent (in) and effluent (out). NH₄—N concentration was measured by on-line sensors. PO₄—P concentration was measured by filtering “grab” samples of the wastewater through a 1-micron filter, and then analysing the filtered wastewater with a Merck Millipore phosphate test kit and a Merck Spectroquant NOVA 60 Spectrophotometer.

The data in FIG. 3B clearly demonstrate that phosphorus (and nitrogen in the form of ammonium) was efficiently removed by this method. As shown in FIG. 3B, the effluent concentration of phosphorus (PO₄—P) was very low, 0.1 mg/l or less. This method is at least as effective as analogous methods that employ a constant DO-setpoint in terms of removing phosphorus from wastewater.

The discussion above in relation to Example 1 is also applicable to this Example.

1. A method for enhanced biological phosphorus removal from water by a biofilm, said method comprising:
(i) an anaerobic step in which said biofilm is subjected to anaerobic conditions;
(ii) an aerated step in which said biofilm is subjected to aerated conditions by supplying oxygen to the water;
(iii) detecting the level of nitrite and/or nitrate in the water in or after aerated step (ii);
wherein the amount of oxygen supplied in aerated step (ii) is dependent on the level of nitrite and/or nitrate detected.

2. The method of claim 1, wherein said biofilm is present on free flowing biofilm carriers.

3. The method of claim 1, wherein said water is wastewater.

4. The method of claim 1, wherein said method is performed in a reactor, preferably a Moving Bed Biofilm Reactor (MBBR).

5. The method of claim 4, said biofilm is present on biofilm carriers and wherein the filling ratio of biofilm carriers is between 1% and 100%, preferably between 30% to 75%, of the wet volume of the reactor.

6. The method of claim 1, wherein said method is a continuous method.

7. The method of claim 1, wherein said anaerobic step (i) is carried out in an anaerobic zone of a reactor and said aerated step (ii) is carried out in an aerated zone of a reactor.

8. The method of claim 1, wherein said anaerobic zone and/or said aerated zone is sub-divided into a plurality of sub-chambers.

9. The method of claim 1, wherein the biofilm is present on biofilm carriers and at the end of the aerated step said biofilm carriers are transferred from the aerated chamber to the anaerobic chamber without significant transfer of water.

10. The method of claim 9, wherein said transfer is performed by a mechanical device, preferably said mechanical device is an elevator, transport screw or conveyer belt.

11. The method of claim 1, wherein said oxygen is supplied in the form of air, preferably by a bubble diffuser or blower.

12. The method of claim 1, wherein the level of nitrite (NO₂) is detected.

13. The method of claim 1, wherein the level of nitrate (NO₃) is detected.

14. The method of claim 1, wherein the level of nitrite (NO₂) and nitrate (NO₃) is detected.

15. The method of claim 1, wherein the level of nitrite and/or nitrate is detected by one or more in-line sensors.

16. The method of claim 1, wherein the amount of oxygen supplied in aerated step (ii) is decreased in response to the detection of an increased, or increasing, level of nitrite, preferably said amount of oxygen supplied in aerated step (ii) is decreased by decreasing a DO-setpoint.

17. The method of claim 1, wherein the amount of oxygen supplied in aerated step (ii) is increased in response to the detection of a decreased, or decreasing, level of nitrite and/or nitrate, preferably said amount of oxygen supplied in aerated step (ii) is increased by increasing a DO-setpoint.

18. The method of claim 16, wherein said increased or increasing or decreased or decreasing level of nitrite and/or nitrate is an increase or decrease relative to a nitrite and/or nitrate setpoint level.

19. The method of claim 18, wherein said setpoint level of nitrite and/or nitrate is 0.5-5 mg/l, preferably 1-2 mg/l, more preferably 1.5 mg/l.

20. The method of claim 1, wherein in aerated step (ii) there is a continuous supply of oxygen to the water.

21. The method of claim 1, wherein said method achieves biological phosphorus removal from water such that there is a concentration of PO₄—P of less than 0.5 mg/l, preferably less than 0.2 mg/l or less than 0.1 mg/l.

22. The method of claim 1, wherein said method further comprises the removal of nitrogen in the form of ammonium from said water.

23. The method of claim 22, wherein said removal of nitrogen is by simultaneous nitrification-denitrification (SND) by microorganisms in the biofilm.

24. A water treatment system configured to perform the method of claim 1.

25. A water treatment system for enhanced biological phosphorus removal from water by a biofilm, said system comprising
(i) a reactor
(ii) a means for supplying oxygen to said reactor;
(iii) one or more valves through which oxygen can enter said reactor;
(iv) one or more means for determining the concentration of nitrite and/or nitrate in water;
(v) one or more means for determining the concentration of dissolved oxygen (DO) in water; and
(vi) one or more controllers configured to regulate the amount of oxygen entering the reactor, said regulation being dependent on the concentration of nitrite and/or nitrate determined by the means of (iv).
